(19) United States
(12) Patent Application Publication
(10) Pub. No.: US 2009/0115730 A1
(43) Pub. Date: May 7, 2009

(54) Data input device and method thereof

(76) Inventor: Sungsoo Kim, Daegu (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/658,556

(22) PCT Filed: Jul. 30, 2005
(86) PCT No.: PCT/KR2005/002498

§ 371 Date: Jan. 25, 2007

(30) Foreign Application Priority Data
Aug. 4, 2004 (KR) 10-2004-0061305

(51) Int. Cl. G06F 3/02

(52) U.S. Cl. 345/168

(57) ABSTRACT

Disclosed is a data input device and method thereof. The data input device comprises one or more character input buttons and character designation buttons, each having two operating states, input signal generators corresponding respectively to the plurality of buttons and generating input signals when the buttons are pressed, and an input data information generator for generating input data information based on the input signals from the input signal generators, characterized in that said input data information generator includes a memory for storing a button generator connection list showing connection relationship between each button and each corresponding input signal generator, a character assignment list showing relationship each character input button and characters to be assigned to each character input button and a character designation button list showing relationship each character designation button and characters to be designated as input state by each character designation button, and that said input data information generator groups the input signals generated from the input signal generators two by two according to the generation order and determines one character to be designated by the character designation button corresponding to one of each input signal group among the characters to be assigned to the character input button corresponding to the other of each input signal group as an input character based on the three lists stored in the memory.

### CROSS REFERENCE TO RELATED APPLICATION

This application is the National Phase application of International Application No. PCT/KR2004/002498, filed Jul. 30, 2005, which designates the United States and was published in English. This application, in its entirety, is incorporated herein by reference.

### TECHNICAL FIELD

The present invention relates to a data input device and method, and more particularly to a data input device and method for inputting character, number, marking or icon (hereinafter referred to as “character”) in an electric/electronic device that performs a function based on the inputted data.

### BACKGROUND ART

A variety of electric/electronic devices such as mobile phones, PDAs, computers, mouse devices, keypads, remote controllers, game machines, electronic notes, encoders and other terminals (hereinafter referred to as “data inputting electric/electronic devices”) have been developed to perform functions based on data inputted by users.

Such data inputting electric/electronic devices are generally provided with a data input device having a plurality of buttons.

“Buttons” used herein include electronic buttons provided on a touch screen. Each button has two operating states, regardless of whether it is in form of a key or a switch.

FIG. 42 is a perspective view of a mobile phone having a conventional data input device. FIG. 43 is a plan view of the button section in FIG. 42. FIG. 44 is a block diagram of the conventional data input device.

As shown in FIGS. 42 to 44, the conventional data input device is mounted on a main body 1 of the mobile phone. The data input device comprises a dozen of buttons (i.e., buttons 201 to 212), input signal generators 220 corresponding respectively to the buttons 201 to 212 and an input data information generator 230 connected to the input signal generators 220.

FIG. 43 shows buttons 201 to 212 with characters printed thereon.

Buttons 201, 202, 203, 204, 205, 206, 207, 208, 209, 210 and 211 are respectively used as a character input button. Button 212 is used to selectively convert the data input mode for selectively inputting numbers, Korean or English characters.

As generally known in the art, the above buttons can be formed either separately or in a multi-contact type button body.

A multi-contact type button body can be formed to have a single pressure pad and a plurality of contact portions under the pressure pad. The pressure pad has pressure points for selectively pressing the contact portions. The pressure points are made of a synthetic resin. The contact portions and the pressure regions are provided in a number corresponding to the buttons.

The input data information generator 230 includes a memory 231 and an input data determination unit 232 for determining character to be inputted based on an input signal from buttons 201 to 212.

The memory 231 stores a button generator connection list showing connection relationship between each of buttons 201 to 212 and corresponding input signal generator, a character assignment list showing relationship each character input button and characters to be assigned to buttons 201 to 212 and input mode change formation.

The button generator connection list is generated so that buttons 201 to 212 are connected with the input signal generator 220 located directly under each button.

The character assignment list is generated so that all the characters printed on the button are included (see FIG. 45).

The input mode change formation is made as follows.

When there is not a signal or there are three consecutive signals from button 212 (i.e., button 211 is not pressed or pressed consecutively three times), the mobile phone is set in a number input mode.

When there is one signal from button 212 (i.e., button 211 is pressed once), the mobile phone is set in a Korean character input mode.

When there is two consecutive signals from button 212 (i.e., button 211 is pressed twice), the mobile phone is set in an English character input mode.

In each character input mode, a desired character can be inputted by pressing the corresponding button from one to three times, according to the order in which the character is printed on the button. The input data determination unit 232 determines a character corresponding to the pressing number of a button as character to be inputted.

For example, when button 204 is pressed once in the Korean character input mode, the input data determination unit 232 determines [symbol] which is a first Korean character printed on button 204 as character to be inputted. When the same button is pressed twice in the same mode, the input data determination unit 232 determines [symbol] which is a second Korean character printed on button 204 as character to be inputted.

Hereinafter, a method of inputting character data using the conventional data input device will be explained in detail. It is assumed that a Korean word [symbol] and an English word “patent” are to be inputted.

To input the Korean word [symbol] button 212 should be first inputted to activate the Korean character input mode. Subsequently, buttons 206, 206, 203, 204, 208, 208, 202, 201, 209, 209, 202, 201 and 211 should be pressed in sequence.

With the pressing of the above buttons, the input signal generators 220 generate corresponding input signals in order.

Then the input data determination unit 232 determines character to be inputted based on the button generator connection list and the character assignment list, and the input mode change formation.

To be specific, when a signal from the input signal generator corresponding to button 212 is inputted once, the input data determination unit 232 determines that the current number input mode has changed to the Korean character input mode.

When a signal from the input signal generator corresponding to button 206 is inputted twice in the Korean character input mode, the input data determination unit 232 determines that [symbol] has been inputted.

In the same manner, the input data determination unit 232 determines the input of [symbol] by one pressing of button 203, [symbol] by one pressing of button 204, [symbol] by two consecutive pressings of button 208, [symbol] by consecutive pressings of buttons 202 and 201, [symbol] by two consecutive pressings of button 209, [symbol] by consecutive pressings of buttons 202 and 201 and [symbol] by one pressing of button 211.

To input the English word “patent,” button 212 should be pressed twice to activate the English character input mode. Subsequently, buttons 207, 202, 208, 203, 203, 206, 206 and 208 should be pressed in sequence.

With the pressing of the above buttons, the input signal generators 220 generates corresponding input signals in order.

When a signal from the input signal generator corresponding to button 212 is inputted twice consecutively, the input data determination unit 232 determines that the current input mode has changed to the English character input mode.

When a signal from the input signal generator corresponding to button 207 is inputted once in the English character input mode, the input data determination unit 232 determines that “p” has been inputted.

In the same manner, the input data determination unit 232 determines the input of “a” by one pressing of button 202, “t” by one pressing of button 208, “e” by two pressings of button 203, “n” by two consecutive pressings of button 206 and “t” by one pressing of button 208.

In the conventional data input device as explained above, a character can be inputted by pressing the corresponding button once or more times, according to the order in which the character is printed on the button. It is possible to reduce the number of pressings of a button by reducing the number of characters printed on each button. To do so, however, it is necessary to increase the number of buttons, which reduces the effective space of the mobile phone or requires reduction of the size of each button. The reduced size of buttons may increase the possibility that the user presses a wrong button.

If characters are distributed on the increased number of buttons to reduce the number of pressings of each button, it may take more time for the user to find a button with the desired character.

When the button is pressed more or less times, a wrong character may be inputted.

The above problems may arise more frequently when the elderly or people uncomfortable with using hands input character in a small-sized mobile phone or a character data inputting electric/electronic device with a large number of character input buttons for implementing various functions.

### DISCLOSURE OF THE INVENTION

Therefore, the present invention has been made in view of the above-mentioned problems occurring in the prior art, and it is an object of the present invention to provide a data input device to be improved in the space efficiency.

It is other object of the present invention to provide a data input device in which more characters in the same class can be assigned to character input buttons.

It is another object of the present invention to provide a data input device in which an input character can be designated through pressing character designation buttons other than character input button.

In order to accomplish the above object of the present invention, there is provided a data input device comprising one or more character input buttons and character designation buttons, each having two operating states, input signal generators corresponding respectively to the plurality of buttons and generating input signals when the buttons are pressed, and an input data information generator for generating input data information based on the input signals from the input signal generators, characterized in that the input data information generator includes a memory for storing a button generator connection list showing connection relationship between each button and each corresponding input signal generator, a character assignment list showing relationship each character input button and characters to be assigned to each character input button and a character designation button list showing relationship each character designation button and characters to be designated as input state by each character designation button, and that the input data information generator groups the input signals generated from the input signal generators two by two according to the generation order and determines one character to be designated by the character designation button corresponding to one of each input signal group among the characters to be assigned to the character input button corresponding to the other of each input signal group as an input character based on the three lists stored in the memory.

To easily designate characters to be inputted according to character disposition pattern, the character input buttons are grouped into at least one character input button group according to their character disposition pattern. Each character input button belonging to each character input button group includes character print regions that are divided in a number not smaller than the maximum number of characters assigned to each character input button. The characters assigned to it are printed on the character print regions one by one. The character designation button list is generated so that relationship between each character input button group and buttons belonging to each character input button group is included and so that button disposition pattern of each character input button group agrees with character disposition pattern corresponding to each character input button group.

To increase the number of characters that can be inputted, on at least one of character input buttons belonging to each character input button group, characters are printed into a plurality of character sub-groups, each having the same character disposition pattern. The memory stores a sub-group selection button list showing relationship sub-group selection buttons and the character sub-groups selected by each sub-group selection button. The input assignment list is generated so that relationship between each character sub-group and characters belonging to each sub-character group is included. The input data information generator determines the character to be selected by each sub-group selection button as an input character based on the sub-group selection button list stored in the memory.

To reduce the number of buttons, on at least one of character input buttons belonging to each character input button group, characters are printed into a plurality of character sub-groups, each having the same character disposition pattern. Sub-group selection markings for selecting the character sub-groups are printed on at least one of character input buttons. The memory stores a sub-group selection marking list showing relationship the sub-group selection markings and the character sub-groups selected by each sub-group selection marking. The character assignment list is generated so that relationship between each character sub-group and characters belonging to each character sub-group is included. The input data information generator determines the character to be selected by each sub-group selection marking as an input character based on the sub-group selection marking list stored in the memory.

To enable a user to easily find character designation buttons, each character designation buttons belonging to each character input button group is formed in the same shape as the character disposition pattern on the button.

To increase the number of characters or number that can be inputted, the memory stores pair character list showing relationship each character printed on the character input button and its counterpart character. A pair character selection button is separately provided for selecting counterpart character. When an input signal is generated from the input signal generator corresponding to the pair character selection button, the input data information generator determines the counterpart character of the character designated by the character designation button as an input character based on the pair character list stored in the memory.

To easily designate characters to be inputted according to character colors, the character input buttons are grouped into at least one character input button group according to their character colors. On each character input button belonging to each character input button group, characters assigned to it are printed with a different color belonging to the colors assigned to the each character input group. On each character designation button corresponding to each character input button group, a character designation marking is printed with a different color belonging to the colors assigned to the each character input group. The character designation button list is generated so that relationship between each character input button group and buttons belonging to each the character input button group is included, and so that color of each character input button belonging to each character input button group agrees with color of the character designation marking corresponding to each character input button group.

To increase the number of character that can be inputted, on at least one of character input buttons belonging to each character input button group, characters are printed into a plurality of character sub-groups, each having the same group colors. The memory stores a sub-group selection button list showing relationship sub-group selection buttons and the character sub-groups selected by each sub-group selection button. The input assignment list is generated so that relationship between each character sub-group and characters belonging to each sub-character group is included. The input data information generator determines the character to be selected by each sub-group selection button as an input character based on the sub-group selection button list stored in the memory.

To reduce the number of buttons, on at least one of character input buttons belonging to each character input button group, characters are printed into a plurality of character sub-groups, each having the same group colors. Sub-group selection markings for selecting the character sub-groups are printed on at least one of character input buttons. The memory stores a sub-group selection marking list showing relationship the sub-group selection markings and the character sub-groups selected by each sub-group selection markings. The character assignment list is generated so that relationship between each character sub-group and characters belonging to each character sub-group is included. The input data information generator determines the character to be selected by each sub-group selection marking as an input character based on the sub-group selection marking list stored in the memory.

To easily designate characters to be inputted according to character disposition order, the character input buttons are arrayed in a specific order and on the character input button the characters assigned to it printed in the same order. The character designation button list is generated so that button array order agrees with character print order.

To diversify the type of the buttons, at least some of the character input buttons are formed in a multi-contact type button body.

The buttons can be disposed in such a manner that four character input buttons, each having four character print regions disposed in a rectangular pattern, are formed at four corners of a rectangular multi-contact type button body having a parallelogram opening at the center thereof, and other four character input buttons, each having character print regions disposed in a parallelogram pattern, are formed at four corners of a parallelogram multi-contact type button body installed through the parallelogram opening. Alternatively the buttons can be disposed in such a manner that four character input buttons, each having four character print regions disposed in a rectangular pattern, are formed at four arms of a cross-shaped multi-contact type button body, and other four character input buttons, each having four character print regions disposed in a rectangular pattern, are formed separately between every two arms of the cross-shaped multi-contact type button body. Alternatively the buttons can be disposed in such a manner that four character input buttons, each having four character print regions disposed in a rhombic pattern, are formed at four corners of a rhombic outer multi-contact type button body having a rhombic outer opening at the center thereof, and other four character input buttons, each having four character print regions disposed in a rhombic pattern, are formed at four corners of a rhombic inner multi-contact type button body installed through the rhombic outer opening, other four character input buttons, each having four character print regions disposed in a rhombic pattern, are formed are formed separately installed in a rhombic pattern through the rhombic inner opening.

To enable a user to find the character designation button through a finger-reading, each character designation button is provided with a protruded dot or dots for discriminating each other.

To accomplish the above object of the present invention, there is also provided a method for inputting character data using a data input device with one or more character input buttons and character designation buttons, each having two operating states, through steps of pressing the buttons, generating input signals corresponding to the pressed buttons and generating input data information based on the input signals, characterized in that the input data information generation step includes: generating a button generator connection list showing connection relationship between each button and each corresponding input signal generator; generating a character assignment list showing relationship each character input button and characters to be assigned to each character input button; generating a character designation button list showing relationship each character designation button and characters to be designated as input state by each character designation button; grouping groups the input signals generated from the input signal generators two by two according to the generation order; and determining one character to be designated by the character designation button corresponding to one of each input signal group among the characters to be assigned to the character input button corresponding to the other of each input signal group as an input character based on the three lists.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view of a mobile phone having a data input device according to a first embodiment of the present invention;

FIG. 2 is a plan view of the button section in FIG. 1;

FIG. 3 is a block diagram of the data input device according to the first embodiment of the present invention;

FIGS. 4 and 5 are a character assignment list and a character designation button list of the data input device according to the first embodiment of the present invention;

FIG. 6 is a flow chart showing a process of inputting character data using the data input device according to the first embodiment of the present invention;

FIG. 7 is a plan view of a button section of a data input device according to a second embodiment of the present invention;

FIGS. 8 and 9 are a character assignment list and a character designation button list of the data input device in FIG. 7;

FIG. 10 is a plan view of a button section of a data input device according to a third embodiment of the present invention;

FIGS. 11 to 14 are a character assignment list and a character designation button list of the data input device in FIG. 10

FIG. 15 is a plan view of a button section of a data input device according to a fourth embodiment of the present invention;

FIGS. 16 and 17 are a character assignment list and a character designation button list of the data input device in FIG. 15;

FIG. 18 is a plan view of a button section of a data input device according to a fifth embodiment of the present invention;

FIGS. 19 and 20 are a character assignment list and a character designation button list of the data input device in FIG. 18;

FIG. 21 is a plan view of a button section of a data input device according to a sixth embodiment of the present invention;

FIGS. 22 and 23 are a character assignment list and a character designation button list of the data input device in FIG. 21;

FIG. 24 is a plan view of a button section of a data input device according to a seventh embodiment of the present invention;

FIGS. 25 and 26 are a character assignment list and a character designation button list of the data input device in FIG. 24;

FIG. 27 is a plan view of a button section of a data input device according to an eighth embodiment of the present invention;

FIGS. 28 and 29 are a character assignment list and a character designation button list of the data input device in FIG. 27;

FIG. 30 is a plan view of a button section of a data input device according to a ninth embodiment of the present invention;

FIG. 31 is a plan view of a button section of a data input device according to a tenth embodiment of the present invention;

FIGS. 32 and 33 are a character assignment list and a character designation button list of the data input device in FIG. 31;

FIG. 34 is a plan view of a button section of a data input device according to an eleventh embodiment of the present invention;

FIGS. 35 and 36 are a character assignment list and a character designation button list of the data input device in FIG. 34;

FIG. 37 is a plan view of a button section of a data input device according to a twelfth embodiment of the present invention;

FIG. 38 is a block diagram of the data input device in FIG. 37;

FIGS. 39 and 40 are a character assignment list and a character designation button list of the data input device in FIG. 37;

FIG. 41 is a character assignment list of the character input buttons in FIG. 37 including counterpart characters;

FIG. 42 is a perspective view of a mobile phone having a conventional data input device;

FIG. 43 is a plan view of the button section in FIG. 42;

FIG. 44 is a block diagram of the conventional data input device; and

FIG. 45 is a character assignment list of the conventional data input device.

### BEST MODE FOR CARRYING OUT THE INVENTION

Reference will now be made in detail to the preferred embodiments of the present invention.

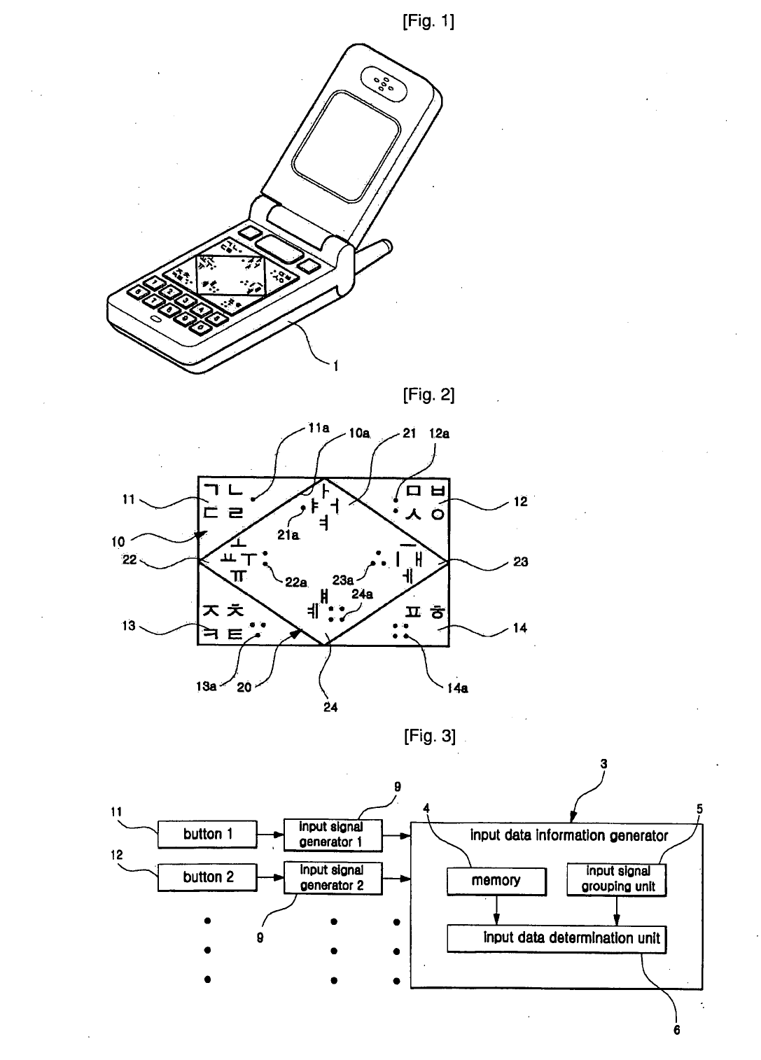

FIG. 1 is a perspective view of a mobile phone having a data input device according to a first embodiment of the present invention. FIG. 2 is a plan view of the button section in FIG. 1. FIG. 3 is a block diagram of the data input device according to the first embodiment of the present invention.

As shown in FIG. 1, the data input device according to the first embodiment of the present invention is provided on a main body 1 of the mobile phone in a similar manner to the conventional device (see FIG. 40). The data input device includes eight buttons 11, 12, 13, 14, 21, 22, 23 and 24, input signal generators 9 corresponding respectively to the eight buttons and an input data information generator 3 connected to all the input signal generators 9.

The eight buttons 11, 12, 13, 14, 21, 22, 23 and 24 are formed in a push-and-pop type.

Buttons 11, 12, 13 and 14 are formed at four corners of a rectangular multi-contact type button body 10 having a parallelogram opening 10a at the center thereof. Similarly, buttons 21, 22, 23 and 24 are formed at four corners of a parallelogram multi-contact type button body 20.

The parallelogram multi-contact type button body 20 is mounted on the main body 1 of the mobile phone through the parallelogram opening 10a formed at the center of the rectangular multi-contact type button body 10.

Each surface of buttons 11, 12, 13, 14 is divided into four character print region in a rectangular disposition pattern and in each character print region one character is printed.

Each surface of buttons 21, 22, 23, 24 is divided into four character print region in a parallelogram disposition pattern and in each character print region one character is printed.

The eight buttons 11, 12, 13, 14, 21, 22, 23 and 24 are grouped into two character input button groups: a rectangular character input button group consisting of buttons 11, 12, 13 and 14 and a parallelogram character input button group consisting of buttons 21, 22, 23 and 24.

The eight buttons 11, 12, 13, 14, 21, 22, 23 and 24 are used as character input button.

The four buttons 11, 12, 13 and 14 are also used as character designation buttons which designate one among the characters printed on character input button 11, 12, 13, 14 as input state for the rectangular character input button group, and the four buttons 21, 22, 23 and 24 are used as character designation buttons which designate one among the characters printed on character input button 21, 22, 23, 24 as input state for the parallelogram character input button group.

The character designation buttons 11, 12, 13, 14, 21, 22, 23 are each provided with a protruded dot or dots. Specifically, buttons 11 and 21 have a single protruded dot 11a and 21a. Buttons 12 and 22 have two protruded dots 12a and 22a. Buttons 13 and 23 have three protruded dots 13a and 23a. Buttons 14 and 24 have four protruded dots 14a and 24a.

The input data information generator 3 includes a memory 4, an input signal grouping unit 5 for grouping the input signals generated from the input signal generators 9 two by two according to the generation order and an input data determination unit 6 for determining character to be inputted based on the grouped input signals.

The input data determination unit 6 recognizes that the first one of each input signal group is generated by the character input button on which a desired character to be printed and that the second one of each input signal group is generated by the character designation button.

The input signal grouping unit 5 and the input data determination unit 6 can be implemented by a separate MICOM or a MICOM which serves as a controller of the mobile phone.

The memory 4 stores a button generator connection list showing connection relationship between each button and each corresponding input signal generator, a character assignment list showing relationship each character input button and characters to be assigned to each character input button and a character designation button list showing relationship each character designation button and characters to be designated as input state by each character designation button.

The button generator connection list is generated so that buttons 11, 12, 13, 14, 21, 22, 23, 24 are connected with the input signal generator 9 located directly under each button.

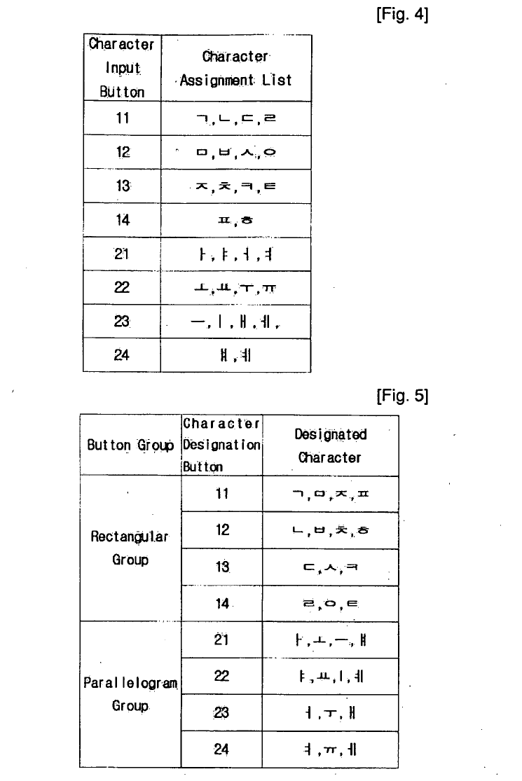

The character assignment list is generated so that all the characters printed on the button are included (see FIG. 4).

The character designation button list is generated so that buttons 11, 12, 13, and 14 are belongs to the rectangular character input button group and buttons 21, 22, 23 and 24 are belongs to the parallelogram character input button group, and so that designation button disposition pattern of each character input button group agrees with character disposition pattern corresponding to each character input button group.

For example, in case of the rectangular character input button group, button 11 is used to designate the top-left characters (i.e., [symbol] on button 11, [symbol] on button 12, [symbol] on button 13 and [symbol] on button 14) and button 12 is used to designate the top-right characters (i.e., [symbol] on button 11, [symbol] on button 12, [symbol] on button 13 and [symbol] on button 14) and Button 13 is used to designate the bottom-left characters (i.e., [symbol] on button 11, [symbol] on button 12 and [symbol] on button 13) and Button 14 is used to designate the bottom-right character (i.e., [symbol] on button 11, [symbol] on button 12 and [symbol] on button 13).

The character designation button list is stored as a table in the memory 4 as shown in FIG. 5.

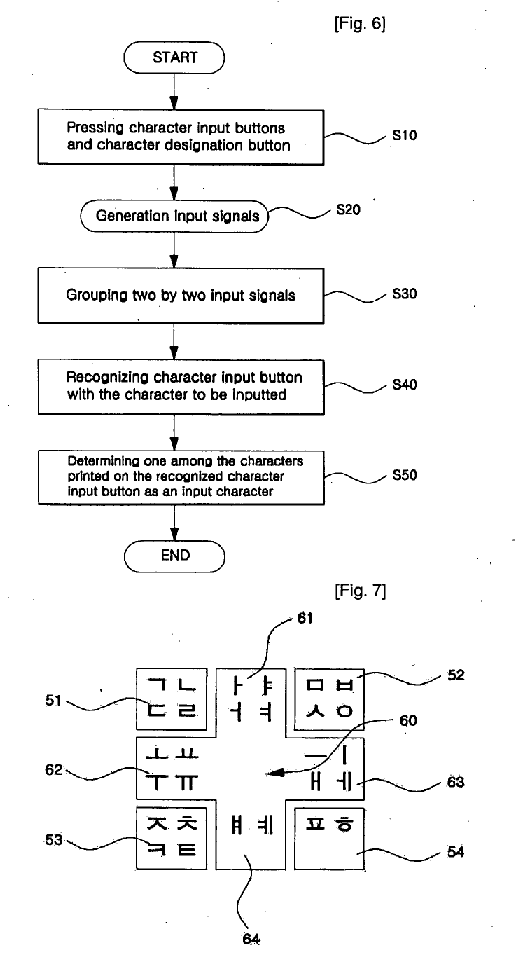

A method for inputting character data using the data input device according to the first embodiment of the present invention will be explained in detail with reference to FIG. 6. It is assumed that a Korean word [symbol] is to be inputted.

To input the Korean word [symbol] the user has to press buttons 13, 14, 23, 21, 11, 11, 14, 12, 21, 23, 13, 12, 21, 23, 12 and 14 in sequence (S10). When pressing buttons the user recognizes the desired character designation button through a finger-reading of a protruded dot or dots formed on the buttons.

With the pressing of the above buttons, the input signal generators 9 generate corresponding input signals in order (S20).

The input signal grouping unit 5 groups two by two input signals generated in order from the input signal generators 9 (S30). In other words, the input signal grouping unit 5 groups the input signals into SG1 (S13, S14), SG2 (S23, S21), SG3 (S11, S11), SG4 (S14, S12), SG5 (S21, S23), SG6 (S13, S12), SG7 (S21, S23) and SG8 (S12, S14). SG refers to an input signal group, S refers to each input signal from the input signal generators 9.

Subsequently, the input signal determination unit 6 determines an input character corresponding to each input signal group based on the three lists stored in the memory 4. Hereinafter, a process of determining an input character corresponding to SG1 and SG2 will be explained in detail.

The input data determination unit 6 determines that the first signal S13 of the input signal group SG1 has been generated by the input signal generator corresponding to button 13 based on the button generator connection list (S40) and then recognizes that button 13 belongs to the rectangular character input button group based on the character designation button list. Also, the input data determination unit 6 determines that the second signal S14 of the input signal group SG1 has been generated by the input signal generator corresponding to button 14 based on the button generator connection list (S40). Then, based on the character designation button list, the input data determination unit 6 recognizes that a Korean consonant [symbol] is designated by the character designation button 14 among [symbol] and [symbol] assigned to character input button 13 and finally determines that an input character corresponding to SG1 is a Korean consonant [symbol] (S50).

Subsequently, the input data determination unit 6 determines that the first signal S23 of the input signal group SG2 has been generated by the input signal generator corresponding to button 23 based on the button generator connection list and then recognizes that button 23 belongs to the parallelogram character input button group based on the character designation button list. Also, the input data determination unit 6 determines that the second signal S21 of the input signal group SG2 has been generated by the input signal generator corresponding to button 21 based on the button generator connection list. Then, based on the character designation button list, the input data determination unit 6 recognizes that a Korean vowel [symbol] is designated by the character designation button 21 among [symbol] [symbol] and [symbol] assigned to character input button 23 and finally determines that an input character corresponding to SG2 is a Korean vowel

[symbol]

In the same manner, the input data determination unit 6 determines that an input character corresponding to SG3 is [symbol] an input character corresponding to SG4 is [symbol] an input character corresponding to SG5 is [symbol] an input character corresponding to SG6 is [symbol] an input character corresponding to SG7 is [symbol] and an input character corresponding to SG8 is

[symbol]

The functions and structures of the input signal generators 9 and the input data information generator 3 as explained in conjunction with FIGS. 1 to 3 are equally applicable to the other embodiments of the present invention. Accordingly, for explanatory convenience, the same drawing reference numerals 9 and 3 will be used respectively for the input signal generators and input data information generator in the other embodiments of the present invention. Also, the following description of the other embodiments will be focused on the structure and operation of buttons excluding the input signal generators 9 and the input data information generator 3.

In the first embodiment of the present invention, every button is used as character designation button. However, only some of the buttons can be used as character designation buttons.

FIG. 7 is a plan view of a button section of a data input device according to the second embodiment of the present invention.

As shown in FIG. 7, the data input device according to the second embodiment of the present invention has eight buttons 51, 52, 53, 54, 61, 62, 63 and 64.

The eight buttons 51, 52, 53, 54, 61, 62, 63 and 64 are formed in a push-and-pop type, and Surface of the buttons is respectively divided into four character print regions in a rectangular pattern. In the character print regions, characters assigned to each buttons are printed as follows.

On the button 51 are printed Korean consonants [symbol] , [symbol] and [symbol] On the button 52 are printed Korean consonants [symbol] [symbol] and [symbol] On the button 53 are printed Korean consonants [symbol] [symbol] and [symbol] On the button 54 are printed Korean consonants [symbol] and [symbol] (Two character printed regions are vacant). On the button 61 are printed Korean vowels [symbol] and [symbol] On the button 62 are printed Korean vowels [symbol] [symbol] and [symbol] On the button 63 are printed Korean vowels [symbol] [symbol] and [symbol] On the button 64 are printed Korean vowels [symbol] and [symbol] (Two character printed regions are vacant).

Buttons 61, 62, 63 and 64 are formed at four arms of a cross-shaped multi-contact type button body 60, and buttons 51, 52, 53 and 54 are formed separately between every two arms of the cross-shaped multi-contact button body 60.

Among the above buttons, buttons 51, 52, 53, 54 61, 62, 63 and 64 are used as both character designation button and character input button, buttons 51, 52, 53 and 54 are used as only character input button.

The memory 4 stores a button generator connection list, a character assignment list and a character designation button list.

The button generator connection list is generated so that buttons 51, 52, 53, 54, 61, 62, 63 and 64 are connected with the input signal generator 9 located directly under each button.

The character assignment list is generated so that all the characters printed on the button are included (see FIG. 8).

The character designation button list is generated so that disposition pattern of buttons 61, 62, 63 and 64 agrees with character disposition pattern of each button.

For example, button 51 is used to designate the top-left character on each button (i.e., [symbol] on button 51, [symbol] on button 52, [symbol] on button 53, [symbol] on button 54, [symbol] on button 61, [symbol] on button 62, [symbol] on button 63 or [symbol] on button 64). Button 52 is used to designate the top-right character on each button ( [symbol] on button 51, [symbol] on button 52, [symbol] on button 53, [symbol] on button 54, [symbol] on button 61, [symbol] on button 62, [symbol] on button 63 or [symbol] on button 64). Button 53 is used to designate the bottom-left character on each button ( [symbol] on button 51, [symbol] on button 52, [symbol] on button 53, [symbol] on button 61, [symbol] on button 62 or [symbol] on button 63). Button 54 is used to designate the bottom-right character on each button ( [symbol] on button 51, [symbol] on button 52, [symbol] on button 53, [symbol] on button 61, [symbol] on button 62 or [symbol] on button 63).

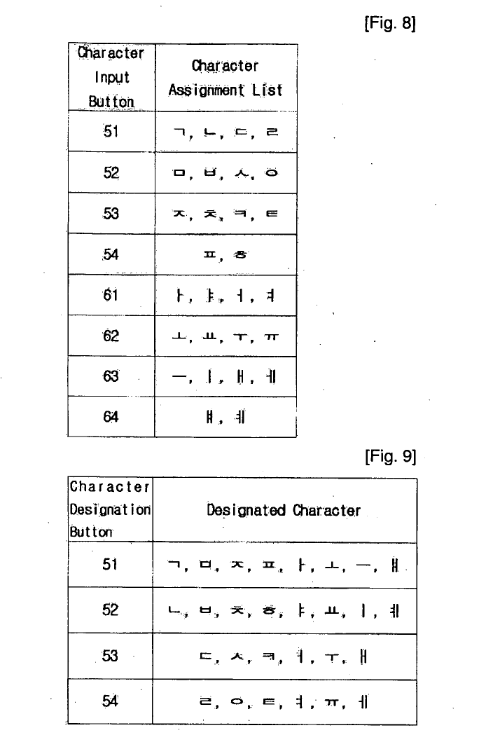

Such character designation, as shown in FIG. 9, can be applied to the other characters.

A method for inputting character data using the data input device according to the second embodiment of the present invention will be explained in detail. It is assumed that a Korean word [symbol] is to be inputted.

To input the Korean word [symbol] the user has to press buttons 53, 54, 63, 51, 51, 51, 54, 52, 61, 53, 53, 52, 61, 53, 52 and 54 in sequence.

The input signal grouping unit 5 groups the input signals into SG1 (S53, S54), SG2 (S63, S51), SG3 (S51, S51), SG4 (S54, S52), SG5 (S61, S53), SG6 (S53, S52), SG7 (S61, S53) and SG8 (S52, S54). SG refers to an input signal group. S refers to each input signal from the input signal generators 9.

Subsequently, the input signal determination unit 6 determines an input character corresponding to each input signal group based on the three lists stored in the memory 4. Hereinafter, a process of determining an input character corresponding to SG1 and SG2 will be explained in detail.

Based on the character designation button list, the input data determination unit 6 recognizes that a Korean consonant [symbol] is designated by the character designation button 54 among [symbol] and [symbol] assigned to character input button 53 and finally determines that an input character corresponding to SG1 is a Korean consonant

[symbol]

Subsequently, based on the character designation button list, the input data determination unit 6 recognizes that a Korean vowel [symbol] is designated by the character designation button 51 among [symbol] [symbol] and [symbol] assigned to character input button 63 and finally determines that an input character corresponding to SG2 is a Korean vowel

[symbol]

In the same manner, the input data determination unit 6 determines that an input character corresponding to SG3 is [symbol] an input character corresponding to SG4 is [symbol] an input character corresponding to SG5 is [symbol] an input character corresponding to SG6 is [symbol] an input character corresponding to SG7 is [symbol] and an input character corresponding to SG8 is

[symbol]

In the data input device according to the above embodiments of the present invention, the buttons are belongs to only one character input button group. However, it is also possible to belong to more character input button groups as will be explained below.

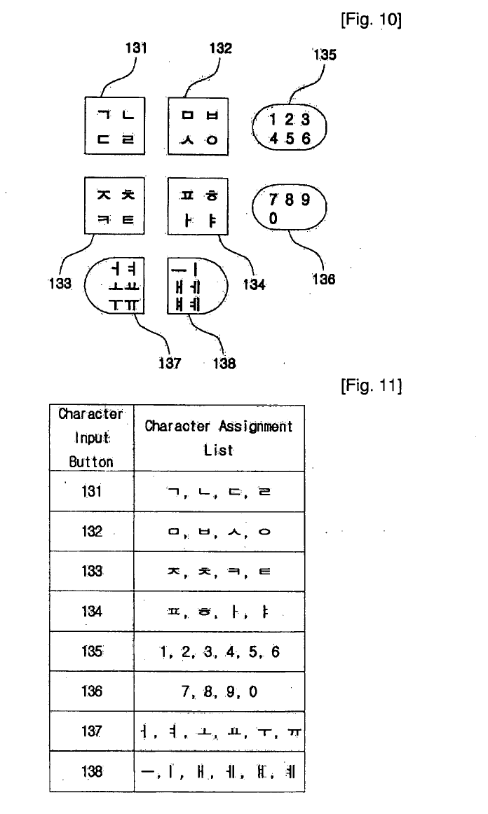

FIG. 10 is a plan view of a button section of a data input device according to the third embodiment of the present invention.

As shown in FIG. 10, the data input device according to the third embodiment of the present invention has eight buttons 131, 132, 133, 134, 135, 136, 137 and 138.

The eight buttons 131 to 138 are separately formed in a push-and-pop type.

Each surface of buttons 131, 132, 133 and 134 is divided into four character regions in 2(column)×2(row) matrix disposition pattern, and each surface of buttons 135 and 136 is divided into six character regions in 3(column)×2(row) matrix disposition pattern and each surface of buttons 137 and 138 is divided into six character regions in 2(column)×3(row) matrix disposition pattern.

According to such character disposition pattern, the eight buttons 131 to 138 can be grouped into three character input button groups: a square character input button group consisting of buttons 131, 132, 133 and 134; a horizontally-wide character input button group consisting of buttons 135 and 136; and a vertically-long character input button group consisting of buttons 137 and 138.

Buttons 131, 132, 133 and 134 are used as character designation buttons for the square character input button group, horizontally-wide character input button group or vertically-long character input button group. Buttons 135 and 136 are used as character designation buttons for the horizontally-wide character input button group. Buttons 137 and 138 are used as character designation buttons for the vertically-long character input button group.

All the eight buttons 131 to 137 are used as character input button.

The memory 4 stores a button generator connection list, a character assignment list and a character designation button list.

The button generator connection list is generated so that buttons 131, 132, 133, 134, 135, 136, 137 and 138 are connected with the input signal generator 9 located directly under each button.

The character assignment list is generated so that all the characters printed on the button are included (see FIG. 11).

The character designation button list is generated so that disposition pattern of buttons 131, 132, 133, 134, 135, 136, 137 and 138 coincides with character disposition pattern of each button.

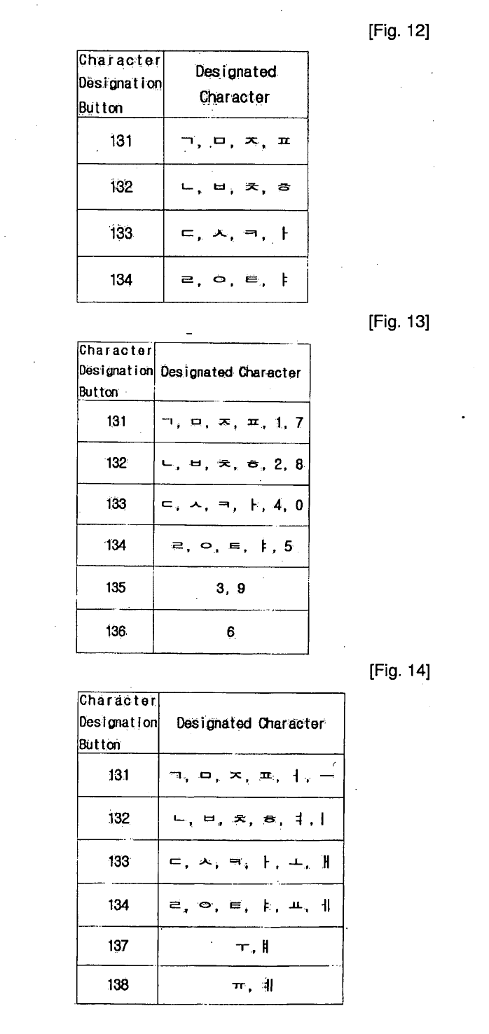

For example, button 131 is used to designate the top-left character on each button in the square character input button group (i.e., [symbol] on button 131, [symbol] on button 132, [symbol] on button 133 or [symbol] on button 134) (see FIG. 12). Button 135 is used to designate the top-right number on each button in the horizontally-wide character input button group (“3” on button 135 and “9” on button 136) (see FIG. 13). Button 137 is used to designate the bottom-left character on each button in the vertically-long character input button group ( [symbol] on button 137 and [symbol] on button 138) (see FIG. 14).

Such character designation, as shown in FIGS. 12, 13 and 14, can be applied to any other characters.

A method for inputting character data using the data input device according to the third embodiment of the present invention will be explained in detail.

It is assumed that [symbol] “4” and [symbol] are to be inputted according to the third embodiment. When button 131, 132, 133 or 134 is pressed previously as character input button, the input data determination unit 6 determines character to be inputted based on the character designation button for the square character input button group (the input data determination unit 6 can be set to determine based on the character designation button for either the horizontally-wide character input button group or the vertically-long character input button group).

To input [symbol] “4” and [symbol] the user has to press buttons 131, 132, 135, 133, 137 and 138 in sequence.

With the pressing of the above buttons, the input signal generators 9 generate corresponding input signals in order.

The input signal grouping unit 5 groups the input signals into SG1 (S131, S132), SG2 (S135, S133) and SG3 (S137, S138).

Subsequently, the input signal determination unit 6 determines an input character corresponding to each input signal group based on the three lists stored in the memory 4 as follows.

Based on the character designation button list for the square character input button group, the input data determination unit 6 recognizes that a Korean consonant [symbol] is designated by the character designation button 132 among [symbol] [symbol] and [symbol] assigned to character input button 131 and finally determines that an input character corresponding to SG1 is a Korean consonant

[symbol]

The input data determination unit 6 recognizes that button 135 belongs to the horizontally-wide character input button group based on the character designation button list. Then, based on the character designation button list for the horizontally-wide character input button group, the input data determination unit 6 recognizes that “4” is designated by the character designation button 133 among “1”, “2”, “3”, “4”, “5” and “6” assigned to character input button 135 and finally determines that an input character corresponding to SG2 is “4”.

The input data determination unit 6 recognizes that button 137 belongs to the vertically-long character input button group based on the character designation button list. Then, based on the character designation button list for the vertically-long character input button group, the input data determination unit 6 recognizes that [symbol] is designated by the character designation button 137 among [symbol] [symbol] [symbol] and [symbol] assigned to character input button 137 and finally determines that an input character corresponding to SG3 is

[symbol]

According to the above embodiments of the present invention, each button of the data input device is shaped regardless of the pattern in which characters are disposed on each button. According to the fourth embodiment of the present invention, however, each button can be formed in a shape similar to the character disposition pattern.

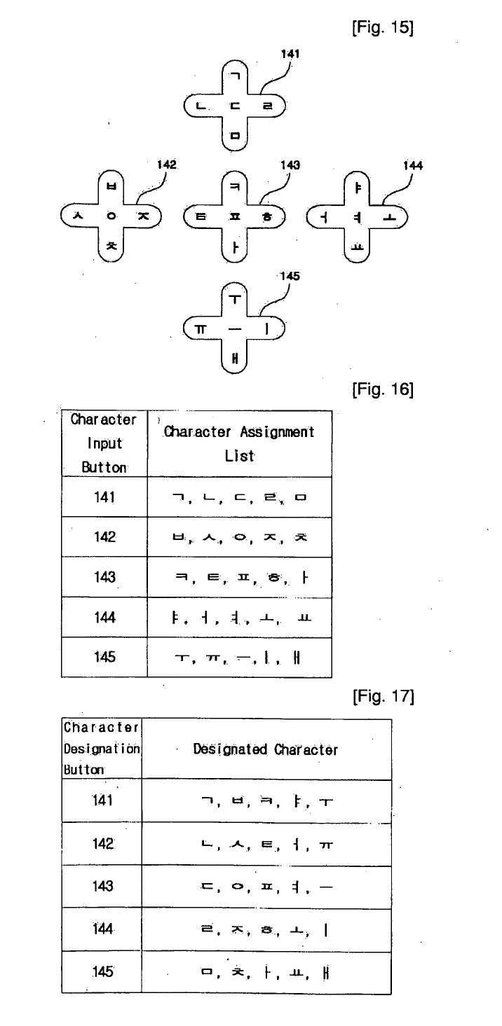

FIG. 15 is a plan view of a button section of a data input device according to the fourth embodiment of the present invention.

As shown in FIG. 15, the data input device according to the fourth embodiment of the present invention has five buttons 141, 142, 143, 144 and 145.

The five buttons 141, 142, 143, 144 and 145 are each formed in a push-and-pop type and in a cross shape.

Each surface of buttons 141, 142, 143, 144 and 145 is divided into five character regions in a cross-shaped pattern.

The data input device according to the fourth embodiment of the present invention as shown in FIG. 15 can generate and store a button generator connection list, a character assignment list and a character designation button list (see FIGS. 16 and 17) in the same manner as explained above in relation to the first embodiment of the present invention. Also, the data input device according to the fourth embodiment of the present invention can input character in the same manner as explained above in relation to the first embodiment. Accordingly, no further explanation of the data inputting process will be made.

The data input device according to the fourth embodiment of the present invention (FIG. 15) is characterized by the shape of the buttons 141, 142, 143,144 and 145. Since the shape of each button is similar to the character disposition pattern of the five buttons, the user can easily find character designation button.

According to the first through fourth embodiments of the present invention, a character designation button list is generated so that button disposition pattern of character input button group agrees with character disposition pattern corresponding to each character input button group. According to the fifth embodiment of the present invention, however, a character designation button list is generated so that designation marking colors of character input button group agrees with character colors corresponding to each character input button group.

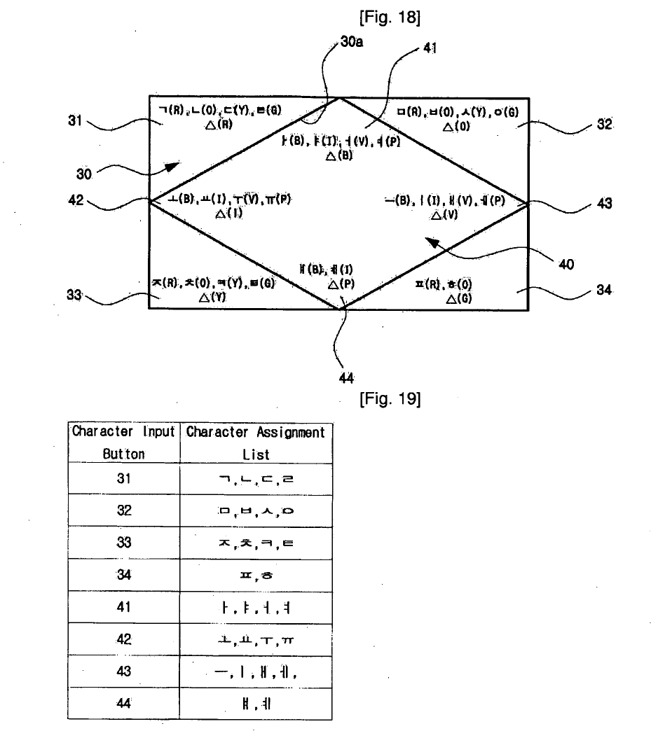

FIG. 18 is a plan view of a button section of a data input device according to the fifth embodiment of the present invention.

As shown in FIG. 18, the data input device according to the fifth embodiment of the present invention has eight buttons 31, 32, 33, 34, 41, 42, 43 and 44.

The eight buttons 31, 32, 33, 34, 41, 42, 43 and 44 are formed in a push-and-pop type. The four buttons 31, 32, 33 and 34 are disposed in a rectangular pattern and the other buttons 41, 42, 43 and 44 are disposed in a rhombic pattern. Surface of the eight buttons is respectively divided into four character print regions in a line. In the character print regions of four buttons 31, 32, 33 and 34 characters assigned to each button are printed in different colors (red, orange, yellow and green, respectively), and a triangular character designation marking is printed in different colors (red, orange, yellow and green, respectively). Similarly, on surface of the other four buttons 41, 42, 43 and 44 characters assigned to each button are printed in different colors (blue, indigo, violet and pink, respectively), and a triangular character designation marking is printed in different colors (blue, indigo, violet and pink, respectively). In FIG. 18, R, O, Y and G refer respectively to red, orange, yellow and green colors. Also, B, I, V and P refer respectively to blue, indigo, violet and pink colors.

For example, on the surface button 31 are printed four characters [symbol] [symbol] and [symbol] in red (R), orange (O), yellow (Y) and green (G) colors, respectively, and a red character designation marking “Δ”.

The eight buttons 31, 32, 33, 34, 41, 42, 43 and 44 are grouped into two character input button groups so that the character designation marking colors of character input button group agrees with character colors corresponding to each character input button group.

One of the two character input button groups is an ROYG character input button group consisting of buttons 31, 32, 33 and 34 having red, orange, yellow and green triangular character designation markings, respectively, and each has four or less characters printed in red, orange, yellow and green colors in order. The other is a BIVP character input button group consisting of buttons 41, 42, 43 and 44 having blue, indigo, violet and pink character designation markings, respectively, and each has four or less characters printed in blue, indigo, violet and pink colors in order.

The ROYG character input button group is formed on a rectangular multi-contact button body 30, while the BIVP character input button group is formed on a parallelogram multi-contact button body 40.

The parallelogram multi-contact button body 40 is mounted on the main body 1 of the mobile phone through the parallelogram opening 30a formed at the center of the rectangular multi-contact type button body 30.

Buttons 31, 32, 33 and 34 are used as character designation button for the ROYG character input button group, and the other buttons 41, 42, 43 and 44 are used as character designation button for the BIVP character input button group.

The eight buttons 31, 32, 33, 34, 41, 42, 43 and 44 are also used to as character input button.

The memory 4 stores a button generator connection list, a character assignment list and a character designation button list.

The button generator connection list is generated so that buttons 31, 32, 33, 34, 41, 42, 43 and 44 are connected with the input signal generator 9 located directly under each button.

The character assignment list is generated so that all the characters printed on the button are included (see FIG. 19).

The character designation button list is generated so that buttons 31, 32, 33, and 34 are belongs to the ROYG character input button group and buttons 41, 42, 43 and 44 are belongs to the BIVP character input button group, and so that character designation marking colors of character input button group agrees with character colors corresponding to each character input button group.

For example, button 31 is used to designate the red character on each button in the ROYG character input button group (i.e., [symbol] on button 31, [symbol] on button 32, [symbol] on button 33 or [symbol] of button 34). Button 32 is used to designate the orange character on each button in the ROYG character input button group (i.e., [symbol] on button 31, [symbol] on button 32, [symbol] on button 33 or [symbol] on button 34). Button 33 is used to designate the yellow character on each button in the ROYG character input button group (i.e., [symbol] on button 31, [symbol] on button 32 or [symbol] on button 33). Button 34 is used to designate the green character on each button in the ROYG character input button group (i.e., [symbol] on button 31, [symbol] on button 32 or [symbol] on button 33).

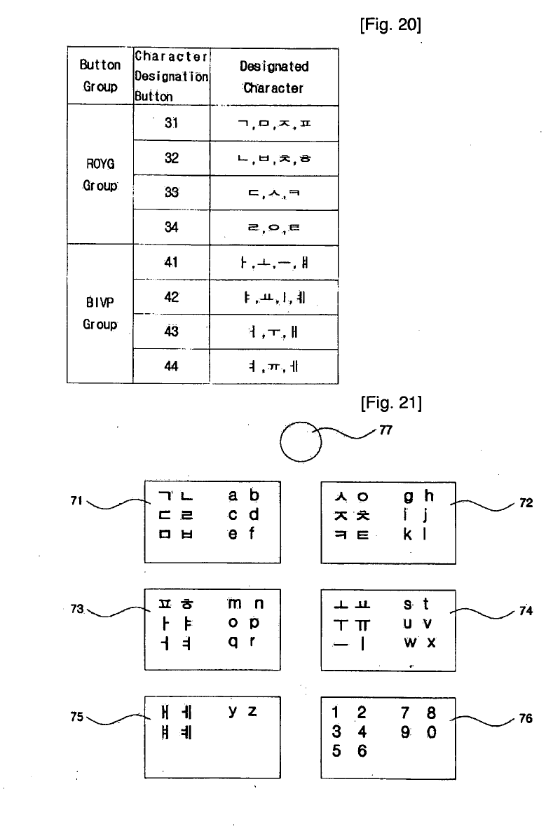

Such character designation, as shown in FIG. 20, can be applied to any other characters.

It is possible to input character data using the data input device having the above structure in the same manner as explained in relation to the first embodiment of the present invention (FIGS. 1 to 3).

Although FIG. 18 illustrates the data input device with each button having a triangular character designation marking and characters disposed in a line, there is no limitation in the shape of the character designation marking or the disposition of the characters. The character designation marking can be of any shape and can be each button itself. Also, the characters can be disposed in a square or any other pattern.

According to the first through fifth embodiments of the present invention, a single group of characters are assigned to each character input button. However, it is also possible to assign of two or more group of characters are assigned to each character input button.

FIG. 21 is a plan view of a button section of a data input device according to the sixth embodiment of the present invention.

As shown in FIG. 21, the data input device according to the sixth embodiment of the present invention has seven buttons 71, 72, 73, 74, 75, 76 and 77.

The seven buttons 71 to 77 are formed in a push-and-pop type. Two sub-groups of characters (i.e., left group or right group) are assigned to buttons 71 to 76. Each character sub-group consists of six or less characters aligned in two rows.

Buttons 71 to 76 are used to input as both character input button and character designation button. Button 77 is used as sub-group selection button for selecting one of the two character sub-groups assigned to each of buttons 71 to 76.

The memory 4 stores a button generator connection list, a character assignment list, a character designation button list and a sub-group selection button list.

The button generator connection list is generated so that buttons 71, 72, 73, 74, 75, 76 and 77 are connected with the input signal generator 9 located directly under each button.

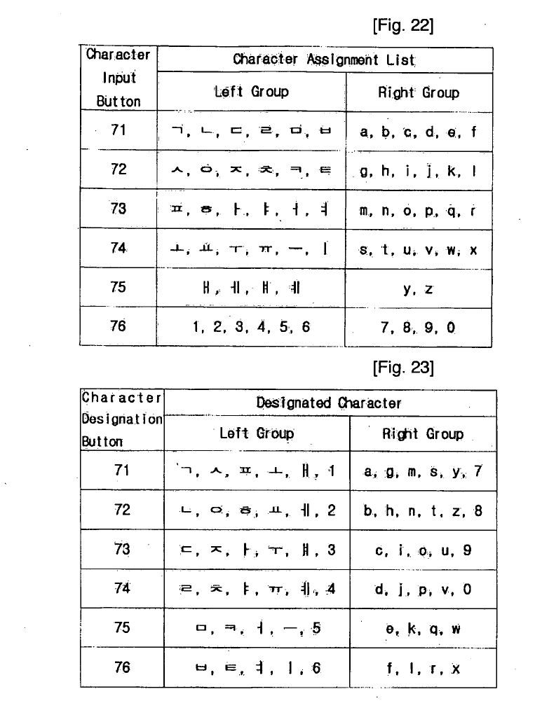

The character assignment list is generated so that all the characters printed on the button are included and that information about the assigned character sub-groups to each character input button is included (see FIG. 22).

The character designation button list is generated so that disposition pattern of buttons 71, 72, 73, 74, 75, 76 and 77 agrees with character disposition pattern of each character input button.

For example, character designation buttons for designating one of the characters assigned to button 72 are as follows.

Button 71 is used to designate [symbol] or “g” of button 72. Button 72 is used to designate [symbol] or “h” of button 72. Button 73 is used to designate [symbol] or “i” of button 72. Button 74 is used to designate [symbol] or “j” of button 72. Button 75 is used to designate [symbol] or “k” of button 72. Button 76 is used to designate [symbol] or “l” of button 72.

Such character designation, as shown in FIG. 23, can be applied to any other characters.

The sub-group selection button list is generated so that one of the two character sub-groups assigned to buttons 71 to 76 is selected according to two operating states of button 77.

For example, when the input signal generator 9 corresponding to button 77 generates no input signal, the characters in the left group is selected as character to be inputted. To the contrary, when the input signal generator 9 corresponding to button 77 generates an input signal, the characters in the right group is selected as character to be inputted.

A method for inputting character data using the data input device according to the sixth embodiment of the present invention will be explained in detail. It is assumed that a Korean word [symbol] and an English word “patent” are to be inputted.

To input the Korean word [symbol] the user has to press buttons 72, 76, 74, 75, 71, 71, 73, 72, 73, 75, 72, 74, 73, 75, 72 and 72 in sequence.

With the pressing of the above buttons, the input signal grouping unit 5 groups the input signals into SG1 (S72, S76), SG2 (S74, S75), SG3 (S71, S71), SG4 (S73, S72), SG5 (S73, S75), SG6 (S72, S74), SG7 (S73, S75) and SG8 (S72, S72).

Subsequently, the input signal determination unit 6 determines character to be inputted based on the button generator connection list, the character assignment list, the character designation button list and the sub-group selection button list stored in the memory 4.

Hereinafter, a process of determining input data from SG1 and SG2 by the input data determination unit 6 will be explained in detail.

When there is no input signal from the input signal generator 9 corresponding to button 77, the data input device recognizes that a mode of inputting characters in the left group has been selected based on the sub-group selection button list stored in the memory 4.

Based on the character designation button list, the input data determination unit 6 determines that an input character corresponding to SG1 is a Korean consonant

[symbol]

Subsequently, based on the character designation button list, the input data determination unit 6 determines that an input character corresponding to SG2 is a Korean vowel

[symbol]

In the same manner, the input data determination unit 6 determines that an input character corresponding to SG3 is [symbol] an input character corresponding to SG4 is [symbol] an input character corresponding to SG5 is [symbol] an input character corresponding to SG6 is [symbol] an input character corresponding to SG7 is [symbol] and an input character corresponding to SG8 is

[symbol]

To input the English word “patent,” the user has to press buttons 77, 73, 74, 71, 71, 74, 72, 71, 75, 73, 72, 74 and 72 in sequence.

With the pressing of the above buttons, the input signal grouping unit 5 groups the input signals into SG1 (S73, S74), SG2 (S71, S71), SG3 (S74, S72), SG4 (S71, S75), SG5 (S73, S72) and SG6 (S74, S72).

Hereinafter, a process of determining input data from SG1 and SG2 by the input data determination unit 6 will be explained in detail.

When the input signal generator 9 corresponding to button 77 generates an input signal, the data input device recognizes that a mode of inputting characters in the right group has been selected based on the sub-group selection button list stored in the memory 4.

Based on the character designation button list, the input data determination unit 6 determines that an input character corresponding to SG1 is an English character “p”.

Subsequently, based on the character designation button list, the input data determination unit 6 determines that an input character corresponding to SG2 is an English character “a”.

In the same manner, the input data determination unit 6 determines that an input character corresponding to SG3 is “t”, an input character corresponding to SG4 is “e”, an input character corresponding to SG5 is “n” and an input character corresponding to SG6 is “t”.

As explained above in conjunction with FIG. 21, when an input signal from an input signal generator corresponding to any character input button is generated without a previous input signal from the input signal generator corresponding to button 77, the data input device recognizes that the mode of inputting characters in the left group on each button has been selected. The user can change the input mode to input characters in the left group or those in the right group in turn by repeatedly pressing button 77.

Button 77 may be formed in a non-push-and-pop type.

Then, the data input device can be set to activate the left group input mode when button 77 is pushed (pressed once) and activate the right group input mode when button 77 is popped up (pressed twice).

Although a single button 77 is used to select one of two different sub-groups of characters according to the sixth embodiment of the present invention, a plurality of buttons can be used to select one of three or more sub-groups of characters. For example, when three or four different subgroups of characters are assigned to each button of a data input device, two sub-group selection buttons can be used for character sub-group selection.

The data input device as shown in FIG. 21 activates the right or left group character input mode according to the number of pressings of the character sub-group selecting button (button 77). It is also possible to set the data input device to activate the right or left group input mode according to specific character (i.e., a sub-group selection marking) inputted from a character input button.

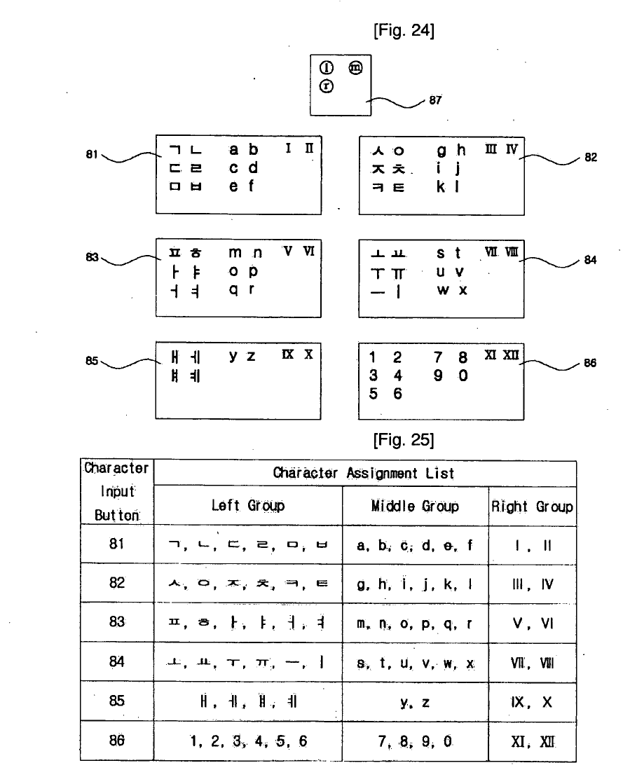

FIG. 24 is a plan view of a button section of a data input device according to the seventh embodiment of the present invention.

As shown in FIG. 24, the data input device according to the seventh embodiment of the present invention has seven buttons 81, 82, 83, 84, 85, 86 and 87.

The seven buttons 81 to 87 are formed in a push-and-pop type. To each of Buttons 81 to 86 are assigned three groups of characters (i.e., left group, middle group and right group). Each character sub-group consists of six or less characters aligned in two rows.

Sub-group selection markings \textcircled{l}, \textcircled{m} and \textcircled{r}, each aligned in two rows, are assigned to Button 87. The markings \textcircled{l}, \textcircled{m} and \textcircled{r} refer respectively to left, middle and right groups of characters on buttons 81 to 86.

Buttons 81 to 86 are used to as both character input button and character designation button. Button 87 is used only as character (i.e., Sub-group selection markings) input button.

The memory 4 stores a character assignment list, a character designation button list and a sub-group selection marking list.

The button generator connection list is generated so that buttons 81, 82, 83, 84, 85, 86 and 87 are connected with the input signal generator 9 located directly under each button.

The character assignment list is generated so that all the characters printed on the button are included and that information about the assigned character sub-groups to each character input button is included (see FIG. 25).

The character designation button list is generated so that disposition pattern of buttons 81, 82, 83, 84, 85, 86 and 87 agrees with character disposition pattern of each button.

For example, character designation buttons for designating one of the characters assigned to button 82 and button 87 are as follows.

Button 81 is used to designate [symbol] “g” or “III” of button 82. Button 82 is used to designate [symbol] “h” or IV of button 82. Button 83 is used to designate [symbol] or “i” of button 82. Button 84 is used to designate [symbol] or “j” of button 82. Button 85 is used to designate [symbol] or “k” of button 82. Button 86 is used to designate [symbol] or “l” of button 82.

In addition, button 81 is used to designate \textcircled{l} of button 87 and thereby select the left group of characters. Button 82 is used to designate \textcircled{m} of button 87 and thereby select the middle group of characters. Button 83 is used to designate \textcircled{r} of button 87 and thereby select the right group of characters.

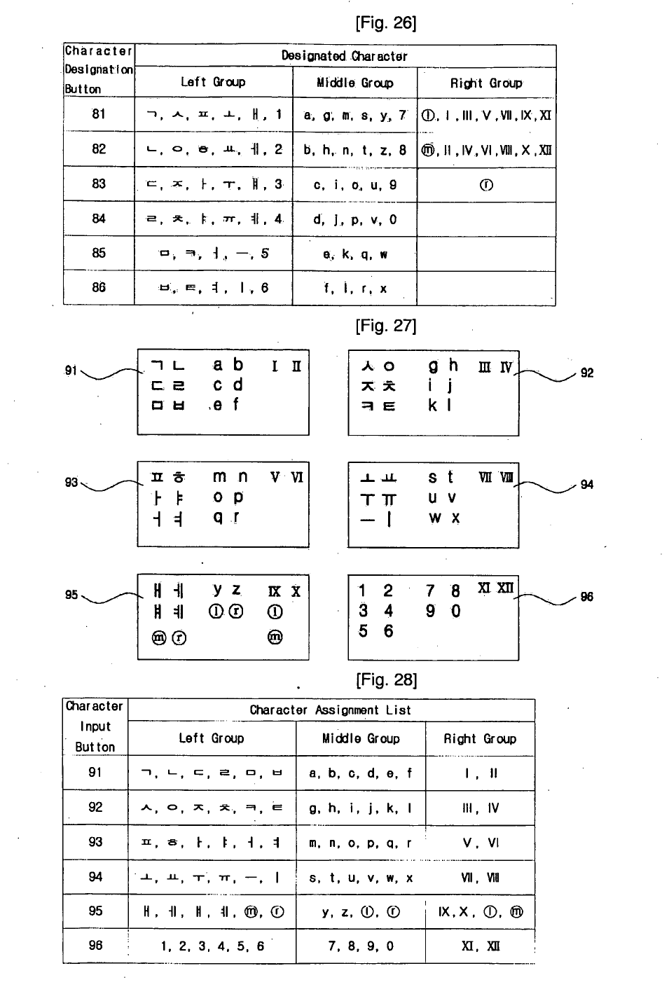

Such character designation, as shown in FIG. 26, can be applied to any other characters.

The sub-group selection marking list is generated so that one of the left, middle and right groups of characters assigned to buttons 81 to 86 can be selected according to a sub-group selection markings inputted through button 87.

In other words, when the input signal generators 9 corresponding to button 87 and button 81 generate input signals, the characters in the left group can be inputted. When the input signal generators 9 corresponding to button 87 and button 82 generate input signals, the characters in the middle group can be inputted. When the input signal generators 9 corresponding to button 87 and button 83 generate input signals, the characters in the right group can be inputted.

A method for inputting character data using the data input device according to the seventh embodiment of the present invention (FIG. 24) will be explained in detail. It is assumed that a Korean word [symbol] an English word “patent” and Roman numbers “III” and “V” are to be inputted.

To input the Korean word [symbol] the user has to press buttons 87, 81, 82, 86, 84, 85, 81, 81, 83, 82, 83, 85, 82, 84, 83, 85, 82 and 82 in sequence.

With the pressing of the above buttons, the input signal grouping unit 5 groups the input signals into SG1 (S87, S81), SG2 (S82, S86), SG3 (S84, S85), SG4 (S81, S81), SG5 (S83, S82), SG6 (S83, S85), SG7 (S82, S84), SG8 (S83, S85) and SG9 (S82, S82).

Subsequently, the input signal determination unit 6 determines character to be inputted based on the button generator connection list, the character assignment list, the character designation button list and sub-group selection marking list stored in the memory 4.

Hereinafter, a process of determining input data from SG2 and SG3 by the input data determination unit 6 will be explained in detail.

When the input signal generators 9 corresponding to button 87 and button 81 generate input signals, the input data determination unit 6 determines that a mode of inputting characters in the left group has been selected based on the sub-group selection marking list stored in the memory 4.

Then, in the same manner as explained with respect to the data input device in FIG. 21, the input data determination unit 6 determines that an input character corresponding to SG2 is a Korean consonant [symbol] and an input character corresponding to SG3 is a Korean vowel

[symbol]

Also, the input data determination unit 6 determines that an input character corresponding to SG4 is [symbol] an input character corresponding to SG5 is [symbol] an input character corresponding to SG6 is [symbol] an input character corresponding to SG7 is [symbol] an input character corresponding to SG8 is [symbol] and an input character corresponding to SG9 is

[symbol]

To input the English word “patent,” the user has to press buttons 87, 82, 83, 84, 81, 81, 84, 82, 81, 85, 83, 82, 84 and 82 in sequence.

With the pressing of the above buttons, the input signal grouping unit 5 groups the input signals into SG1 (S87, S82), SG2 (S83, S84), SG3 (S81, S81), SG4 (S84, S82), SG5 (S81, S85), SG6 (S83, S82) and SG7 (S84, S82).

The input signal determination unit 6 determines that a mode of inputting characters in the middle group has been selected based on the sub-group selection marking list stored in the memory 4. Then, in the same manner as explained with respect to the data input device in FIG. 21, the input data determination unit 6 determines that an input character corresponding to SG2 is “p”, an input character corresponding to SG3 is “a”, an input character corresponding to SG4 is “t”, an input character corresponding to SG5 is “e”, an input character corresponding to SG6 is “n” and an input character corresponding to SG7 is “t”.

To input the Roman numbers “III” and “V,” the user has to press buttons 87, 83, 82, 81, 83 and 81 in sequence.

With the pressing of the above buttons, the input signal grouping unit 5 groups the input signals in generation order into SG1 (S87, S83), SG2 (S82, S81) and SG3 (S83, S81).

The input signal determination unit 6 determines that a mode of inputting Roman numbers in the right group has been selected based on the sub-group selection marking list stored in the memory 4. Then, in the same manner as explained with respect to the data input device in FIG. 21, the input data determination unit 6 determines that an input character corresponding to SG2 is “III” and an input character corresponding to SG3 is “V”.

According to the seventh embodiments of the present invention, a button for inputting the sub-group selection markings is provided separately from the other character input buttons. However, one of character input buttons can be also used for inputting the sub-group selection markings.

FIG. 27 is a plan view of a button section of a data input device according to the eighth embodiment of the present invention.

As shown in FIG. 27, the data input device according to the eighth embodiment of the present invention has six buttons 91, 92, 93, 94, 95 and 96.

The six buttons 91 to 96 having two operating states are formed in a push-and-pop type. Buttons 91 to 96 are each assigned three (left, middle and right) groups of characters. Each character sub-group consists of six or less characters aligned in two rows.

To Button 95 are assigned the sub-group selection markings \textcircled{m} and \textcircled{r} in the left group, \textcircled{l} and \textcircled{r} in the middle group and \textcircled{l} and \textcircled{m} in the right group. The three markings \textcircled{l}, \textcircled{m} and \textcircled{r} refer respectively to left, middle and right groups of characters on each character input button.

Buttons 91 to 96 are all used as both character input button and character designation button. Particularly, button 95 is also used for inputting the sub-group selection markings.

The memory 4 stores a button generator connection list, a character assignment list, a character designation button list and a sub-group selection marking list having an initial selection character sub-group.

The button generator connection list is generated so that buttons 91, 92, 93, 94, 95 and 96 are connected with the input signal generator 9 located directly under each button.

The character assignment list is generated so that all the characters printed on the button are included and that information about the assigned character sub-groups to each character input button is included (see FIG. 28).

The character designation button list is generated so that disposition pattern of buttons 91, 92, 93, 94, 95 and 96 agrees with character disposition pattern of each button.

For example, character designation buttons for designating one of the characters assigned to button 95 are as follows.

Button 91 is used to designate [symbol] “y” or “IX” of button 95. Button 92 is used to designate [symbol] “z” or “X” of button 95. Button 93 is used to designate [symbol] “\textcircled{l}” in the middle group or “\textcircled{l}” in the right group of button 95. Button 94 is used to designate [symbol] or “\textcircled{r}” in the middle group of button 95. Button 95 is used to designate “\textcircled{m}” in the left group or “\textcircled{m}” in the right group of button 95. Button 96 is used to designate “\textcircled{r}” in the left group of button 95.

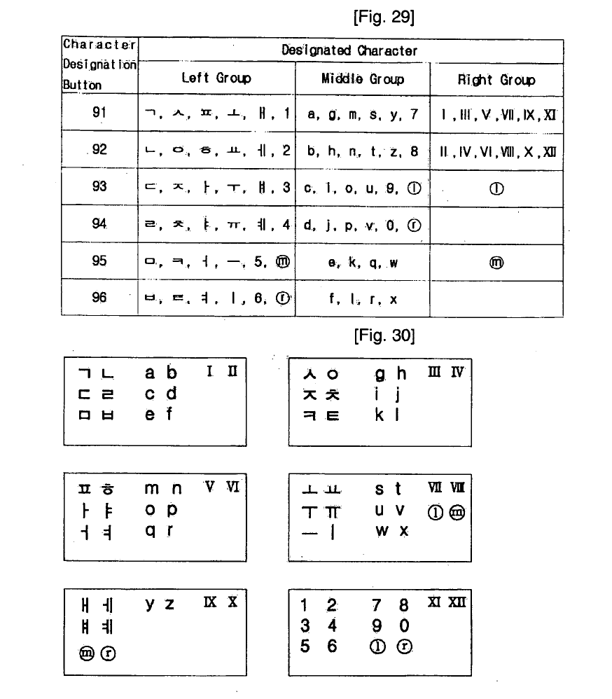

Such character designation, as shown in FIG. 29, can be applied to any other characters.

The sub-group selection marking list is generated so that one of the three character sub-groups assigned to buttons 91 to 96 is selected according to character sub-group selection markings inputted through button 95.

In other words, when the input signal generators 9 corresponding to button 95 and button 93 sequentially generate input signals, the characters in the left group can be selected as character to be inputted.

When the input signal generator 9 corresponding to button 95 generate two consecutive input signals, the characters in the middle group can be selected as character to be inputted.

When the input signal generators 9 corresponding to button 95 and button 86 sequentially generate input signals or when the input signal generators corresponding to button 95 and button 94 sequentially generate input signals, the characters in the right group can be selected as character to be inputted.

The initial selection character sub-group can be one of the left, middle and right groups. For explanatory convenience, it is assumed that the left group on each character input button is set to be the initial selection character sub-group.

A method for inputting character data using the data input device according to the eighth embodiment of the present invention (FIG. 27) will be explained in detail. It is assumed that a Korean word [symbol] an English word “patent” and Roman numbers “III” and “V” are to be inputted.

To input the Korean word [symbol] the user has to press buttons 92, 96, 94, 95, 91, 91, 93, 92, 93, 95, 92, 94, 93, 95, 92 and 92 in sequence.

With the pressing of the above buttons, the input signal grouping unit 5 groups the input signals into SG1 (S92, S96), SG2 (S94, S95), SG3 (S91, S91), SG4 (S93, S92), SG5 (S93, S95), SG6 (S92, S94), SG7 (S93, S95) and SG8 (S92, S92).

Subsequently, the input signal determination unit 6 determines character to be inputted based on the button generator connection list, the character assignment list, the character designation button list and the sub-group selection marking list stored in the memory 4.

Since no signals for a sub-group selection marking is included in the above signal groups, the input data determination unit 6 recognizes that the character sub-group is maintained as the initial selection character sub-group (left group). Then, in the same manner as explained with respect to the data input device in FIG. 21, the input data determination unit 6 determines that an input character corresponding to SG1 is [symbol] an input character corresponding to SG2 is [symbol] an input character corresponding to SG3 is [symbol] an input character corresponding to SG4 is [symbol] an input character corresponding to SG5 is [symbol] an input character corresponding to SG6 is [symbol] an input character corresponding to SG7 is [symbol] and an input character corresponding to SG8 is

[symbol]

To input the English word “patent,” the user has to press buttons 95, 95, 93, 94, 91, 91, 94, 92, 91, 95, 93, 92, 94 and 92 in sequence.

With the pressing of the above buttons, the input signal grouping unit 5 groups the input signals into SG1 (S95, S95), SG2 (S93, S94), SG3 (S91, S91), SG4 (S94, S92), SG5 (S91, S95), SG6 (S93, S92) and SG7 (S94, S92).

Based on the first signal group SG1 (S95, S95), the input signal determination unit 6 determines that the character sub-group is changed to the middle group from the initial selection character sub-group (the left group). Then, in the same manner as explained with respect to the data input device in FIG. 21, the input data determination unit 6 determines that an input character corresponding to SG2 is “p”, an input character corresponding to SG3 is “a”, an input character corresponding to SG4 is “t”, an input character corresponding to SG5 is “e”, an input character corresponding to SG6 is “n” and an input character corresponding to SG7 is “t”.

To input the Roman numbers “III” and “V,” the user has to press buttons 95, 96, 92, 91, 93 and 91 in sequence.

The input signal grouping unit 5 groups the input signals into SG1 (S95, S96), SG2 (S92, S91) and SG3 (S93, S91).

Based on the first signal group SG1 (S95, S96), the input signal determination unit 6 determines that the character sub-group is changed to the right group from the middle group. Then, in the same manner as explained with respect to the data input device in FIG. 21, the input data determination unit 6 determines that an input character corresponding to SG2 is “III” and an input character corresponding to SG3 is “V”.

To input the Roman numbers “III” and “V” right after inputting the English word “patent,” the user has to press buttons 95, 94, 92, 91, 93 and 91 in sequence.

The input signal grouping unit 5 groups the input signals into SG1 (S95, S94), SG2 (S92, S91) and SG3 (S93, S91).

Based on the first signal group SG1 (S95, S94), the input signal determination unit 6 determines that the character sub-group is changed to the right group from the middle group. Then, the input data determination unit 6 determines that an input character corresponding to SG2 is “III” and an input character corresponding to SG3 is “V”.

Although the markings \textcircled{l}, \textcircled{m} and \textcircled{r} are all assigned to a single button according to the eighth embodiment of the present invention (FIG. 27), they can be distributed on two or more character input buttons as shown in FIG. 30.

According to the above embodiments of the present invention, character sub-group selection markings are inputted according to the character disposition pattern on each character input button. Alternatively, character sub-group selection markings can be inputted according to the character colors as shown in FIG. 18.

According to the above embodiments of the present invention, the character designation button list is generated based on the character disposition pattern or the character colors. However, it is also possible to generate the character designation button list based on both the character disposition pattern and the character colors.

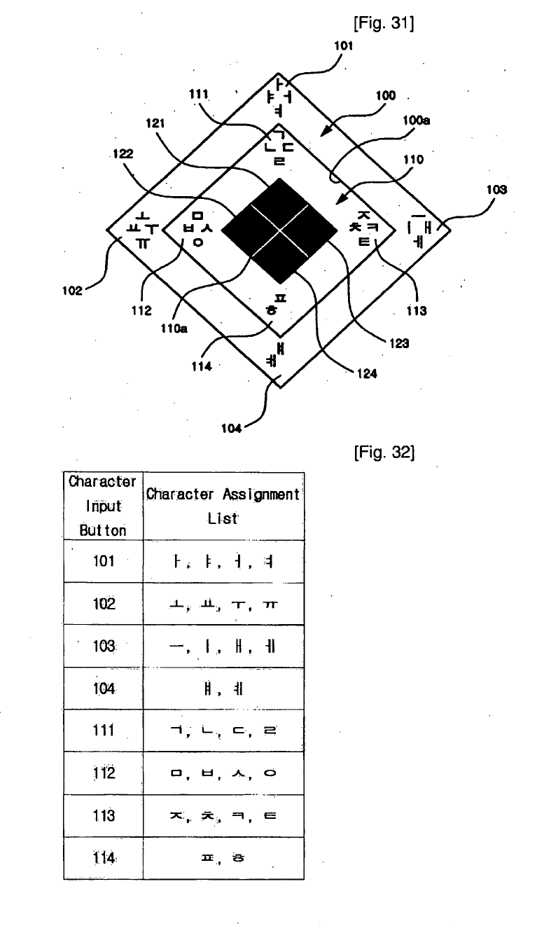

FIG. 31 is a plan view of a button section of a data input device according to the tenth embodiment of the present invention.

As shown in FIG. 31, the data input device according to the tenth embodiment of the present invention has twelve buttons 101, 102, 103, 104, 111, 112, 113, 114, 121, 122, 123 and 124.

The twelve buttons 101, 102, 103, 104, 111, 112, 113, 114, 121, 122, 123 and 124 are formed in a push-and-pop type. Also, the twelve buttons are disposed in three layers each consisting of four buttons.

Each layer is in a rhombic shape. The outer rhombic layer consisting of buttons 101, 102, 103 and 104 and the middle rhombic layer consisting of buttons 111, 112, 113 and 114 are multi-contact type button bodies 100 and 110. By contrast, the center rhombic layer has four separate buttons 121, 122, 123 and 124.

Each surface of buttons 101, 102, 103, 104, 111, 112, 113 and 114 is divided into four character print region in a rhombic disposition pattern and in each character print region, one character is printed in different colors (red, orange, yellow and green, respectively).

For example, On the surface of button 101 four characters [symbol] [symbol] and [symbol] colored red, orange, yellow and green, respectively, are printed in a rhombic pattern.

The surface of buttons 121, 122, 123 and 124 of the center layer are entirely colored red, orange, yellow and green, respectively, which functions respectively as a character designation marking.

The multi-contact type button body 110 of the middle layer, is mounted on the main body 1 of the mobile phone through a rhombic opening 100a formed at the center of the outer multi-contact type button body 100. Similarly, buttons 121, 122, 123 and 124 are mounted on the main body 1 of the mobile phone through a rhombic opening 110a formed at the center of the middle multi-contact button pad 110.

Eight buttons 101, 102, 103, 104, 111, 112, 113 and 114 are used as character input button, and the other buttons 121, 122, 123 and 124 are used as character designation button.

The memory 4 stores a button generator connection list, a character assignment list and a character designation button list.

The button generator connection list is generated so that buttons 101, 102, 103, 104, 111, 112, 113, 114, 121, 122, 123 and 124 are connected with the input signal generator 9 located directly under each button.

The character assignment list is generated so that all the characters printed on the button are included (see FIG. 32).

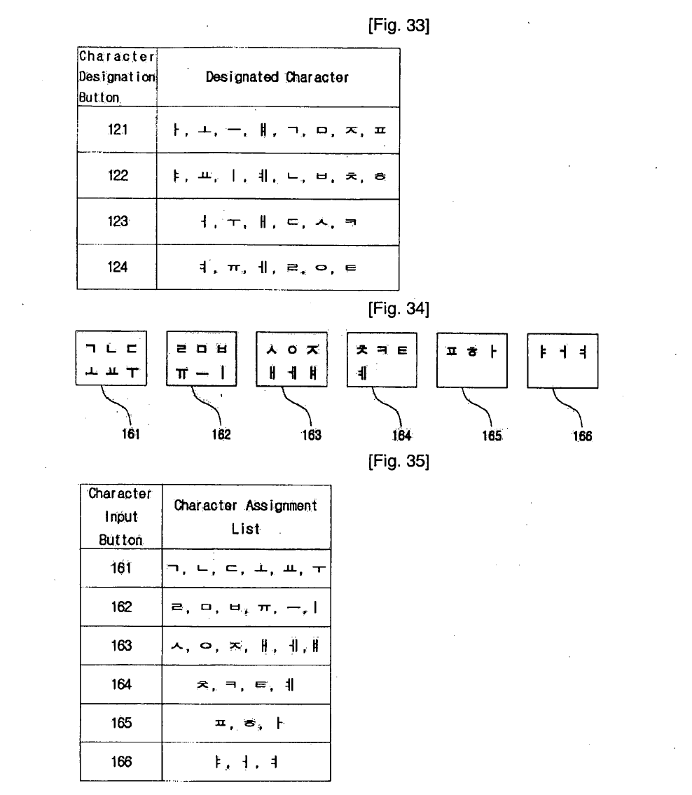

The character designation button list is generated so that disposition pattern of buttons 101, 102, 103, 104, 111, 112, 113, 114, 121, 122, 123 and 124 agrees with character disposition pattern of each button and color of the character designation marking agrees with color of character (see FIG. 33).

For example, buttons for designating one of the characters assigned to button 101 are as follows.

Button 121 is used to designate the top red character [symbol] on button 101. Button 122 is used to designate the left orange character [symbol] on button 101. Button 123 is used to designate the right yellow character [symbol] on button 101. Button 124 is used to designate the bottom green character [symbol] on button 101.

A method for inputting character data using the data input device according to the tenth embodiment of the present invention will be explained in detail. It is assumed that a Korean word [symbol] is to be inputted.

To input the Korean word [symbol] the user has to press buttons 113, 124, 103, 121, 111, 121, 114, 122, 101, 123, 113, 122, 101, 123, 112 and 124 in sequence.

With the pressing of the above buttons, the input signal grouping unit 5 groups the input signals into SG1 (S113, S124), SG2 (S103, S121), SG3 (S111, S121), SG4 (S114, S122), SG5 (S101, S123), SG6 (S113, S122), SG7 (S101, S123) and SG8 (S112, S124).

Hereinafter, a process of determining input character from SG1 by the input data determination unit 6 will be explained in detail.

Based on the character designation button list, the input data determination unit 6 recognizes that a Korean consonant [symbol] is designated by the character designation button 14 among [symbol] [symbol] and [symbol] assigned to character input button 113 and finally determines that an input character corresponding to SG1 is a Korean consonant

[symbol]

In the same manner, the input data determination unit 6 determines that an input character corresponding to SG2 is [symbol] an input character corresponding to SG3 is [symbol] an input character corresponding to SG4 is [symbol] an input character corresponding to SG5 is [symbol] an input character corresponding to SG6 is [symbol] an input character corresponding to SG7 is [symbol] and an input character corresponding to SG8 is

[symbol]

According to the tenth embodiment of the present invention, the character designation button list is generated in consideration of disposition pattern of buttons or color of the character. However, the character designation button list is generated so that the disposition order of buttons agrees with print order of character on each button.

FIG. 34 is a plan view of a button section of a data input device according to the eleventh embodiment of the present invention.

As shown in FIG. 34, the data input device according to the eleventh embodiment of the present invention has six buttons 161, 162, 163, 164, 165 and 166.

The six buttons 161 to 166 are formed in a push-and-pop type and arrayed horizontally in a line.

Each surface of buttons 161 to 166 is divided into six character regions in 3(column)×2(row) matrix disposition pattern.

The six buttons 161 to 166 are all used as both character input button and character designation button.

The memory 4 stores a button generator connection list, a character assignment list and a character designation button list.

The button generator connection list is generated so that buttons 161, 162, 163, 164, 165 and 166 are connected with the input signal generator 9 located directly under each button.

The character assignment list is generated so that all the characters printed on the button are included (see FIG. 35).

The character designation button list is generated so that the disposition order of buttons 161, 162, 163, 164, 165 and 166 agrees with print order of character on each button. It is preferable that the six buttons and the characters on each button should be disposed in a standard order that complies with general ideas on disposition or layout.

In other words, buttons 161 to 166 are disposed in order from leftmost to rightmost. Also, the characters on each button are deemed to have ordinal numbers corresponding to their ordinal (left-to-right and upper-to-lower) disposition.

The character designation button list is generated as follows.

For example, button 161 is used to designate the first character on each button (i.e., [symbol] on button 161, [symbol] on button 162, [symbol] on button 163, [symbol] on button 164, [symbol] on button 165 or [symbol] on button 166). Button 164 is used to designate the second character on each button (i.e., [symbol] on button 161, [symbol] on button 162, [symbol] on button 163 or [symbol] on button 164).

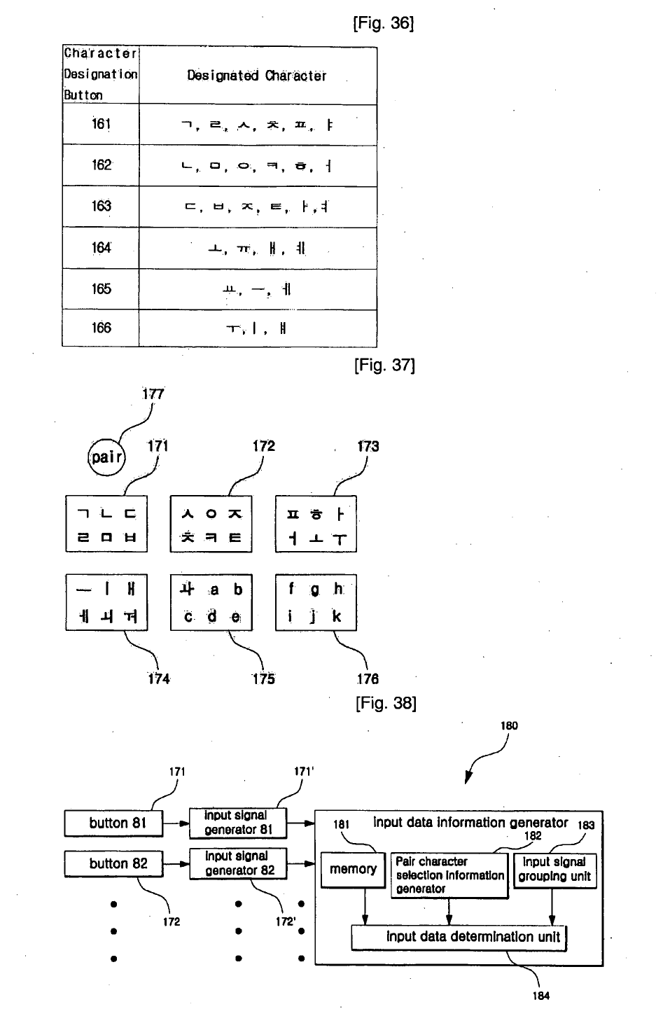

Such character designation, as shown in FIG. 36, can be applied to any other characters.

A method for inputting character data using the data input device according to the eleventh embodiment of the present invention (FIG. 34) will be explained in detail. It is assumed that character data [symbol] is to be inputted.

To input [symbol] the user has to press buttons 164, 161, 166, 162, 163 and 162 in sequence.

With the pressing of the above buttons, the input signal grouping unit 5 groups the input signals into SG1 (S164, S161), SG2 (S166, S162) and SG3 (S163, S162).

Based on the character designation button list, the input data determination unit 6 recognizes that a Korean consonant [symbol] is designated by the character designation button 164 among [symbol] [symbol] and [symbol] assigned to character input button 164 and finally determines that an input character corresponding to SG1 is a Korean consonant

[symbol]

In the same manner, the input data determination unit 6 determines that an input character corresponding to SG2 is [symbol] and an input character corresponding to SG3 is

[symbol]

The first through eleventh embodiments of the present invention provide a data input device and method for inputting only the character printed on the buttons. Hereinafter, a data input device and method for inputting character which is not printed on the buttons will be explained.

FIG. 37 is a plan view of a button section of a data input device according to the twelfth embodiment of the present invention. FIG. 38 is a block diagram of the data input device in FIG. 37.

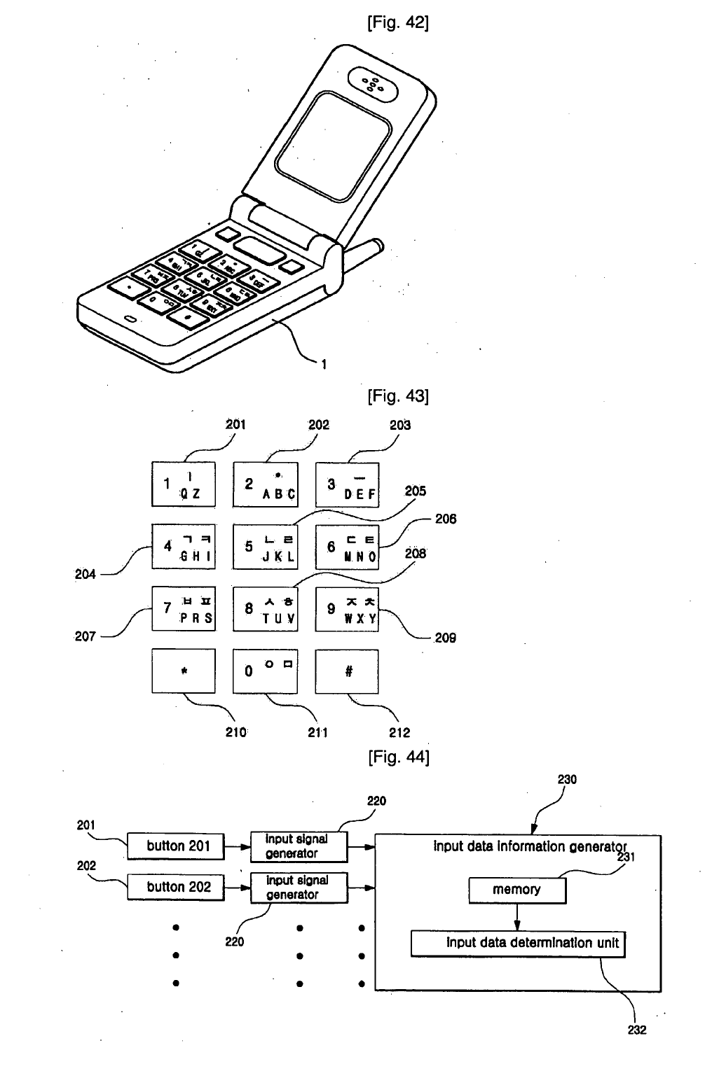

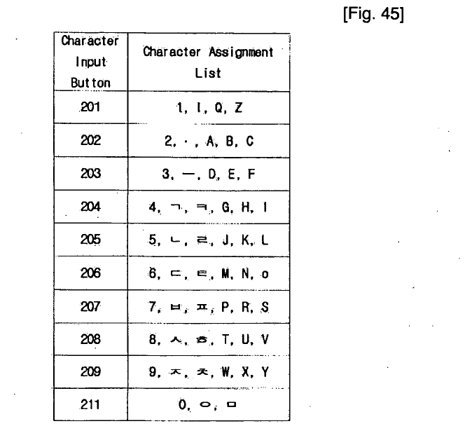

As shown in FIG. 37, the data input device according to the twelfth embodiment of the present invention is mounted on the main body 1 of the mobile terminal (see FIG. 42). The data input device includes seven buttons 171, 172, 173, 174, 175, 176 and 177, input signal generators 171′ to 177′ corresponding respectively to buttons 171 to 177 and an input data information generator 180 connected to the input signal generators 171′ to 177′.

Buttons 171 to 177 are formed in a push-and-pop type.

Each surface of buttons 171 to 176 is divided into six character regions in 3(column)×2(row) matrix disposition pattern.

The six buttons 171 to 176 161 to 166 are all used as both character input button and character designation button.

Button 77 is used as pair character selection button for selecting counterpart character of the character printed on the six buttons 71 to 76.

The input data information generator 180 includes a memory 181, a pair character selection information generator 182 generating pair character selection information based on the signal from the input signal generator 177′ corresponding to pair character selection button 177, an input signal grouping unit 183 for grouping the input signals generated from the input signal generators 171′ to 176′ corresponding to buttons 171 to 176 two by two according to the generation order and an input data determination unit 184 for determining character to be inputted based on the grouped input signals.

The pair character selection information generator 182 generates ordinal information N(x) of an input signal generated from the input signal generator 177′, where x refers to the number of input signals generated from the input signal generators 171′ to 176′ before the an input signal generates from the input signal generator 177′ or between the two input signal generations from the input signal generator 177′.

The input data determination unit 184 recognizes that the first one of each input signal group is generated by the character input button on which a desired character to be printed and that the second one of each input signal group is generated by the character designation button which designates as input state one among the characters assigned to the previously pressed character input button.

The memory 181 stores a button generator connection list, a character assignment list and a character designation button list and a pair character list showing relationship character printed on the character input button and its counterpart character.

The button generator connection list is generated so that buttons 171, 172, 173, 174, 175, 176 and 177 are connected with the input signal generator 171′ to 177′ located directly under each button.

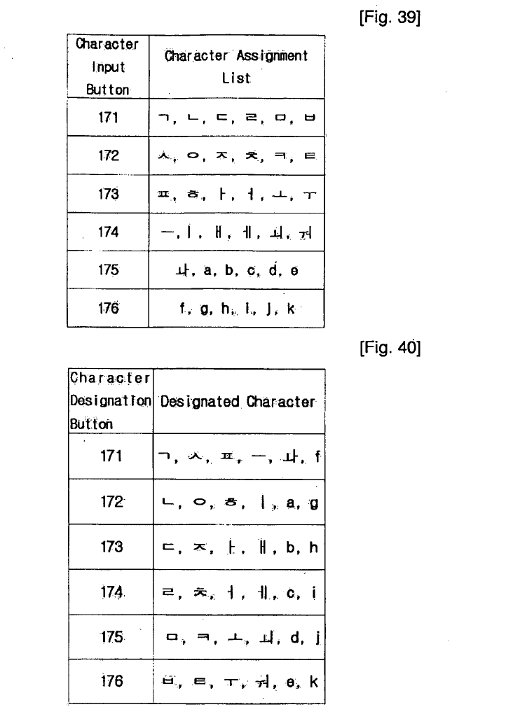

The character assignment list is generated so that all the characters printed on the button are included (see FIG. 39).

The character designation button list is generated so that disposition pattern of buttons 171, 172, 173, 174, 175 and 176 agrees with character disposition pattern of each character button (see FIG. 40).

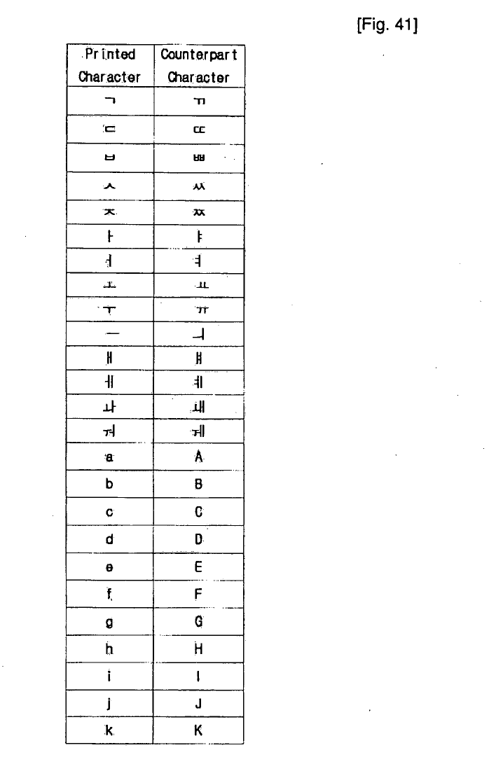

The pair character list is generated so that the counterparts of the Korean characters are tense consonants and complex vowels, and the counterparts of the lowercase English letters printed on the buttons are uppercase English letters (see FIG. 41).

A method for inputting character data using the data input device according to the twelfth embodiment of the present invention (FIG. 37) will be explained in detail. It is assumed that a Korean tense consonant [symbol] a Korean complex vowel [symbol] and an English uppercase letter “I” are to be inputted.

To input the characters [symbol] and “I,” the user has to press buttons 171, 177, 173, 174, 177, 174, 176, 177 and 174 in sequence.

The input signal grouping unit 183 groups only the input signals generated from the input signal generators 171′ to 176′, disregarding the input signals generated from the input signal generator 177′. In other words, the input signal grouping unit 183 groups input signals generated from the input signal generators 1711 to 1761 into SG1 (S171, S173), SG2 (S174, S174) and SG3 (S176, S174).

Simultaneously with the signal grouping by the input signal grouping unit 183, the pair character selection information generator 182 generates ordinal information N(1), N(2) and N(2) of the input signals from the input signal generator 177′ in real time.

The input signal determination unit 184 determines character to be inputted based on the ordinal information N(1), N(2) and N(2) and the button generator connection list, the character assignment list, the character designation button list and the pair character list stored in the memory 181.

Based on the character designation button list, the input data determination unit 184 recognizes that a Korean consonant [symbol] is designated by the character designation button 171 among [symbol] [symbol] [symbol] and [symbol] assigned to character input button 171 and determines that an input character corresponding to SG1 is a Korean consonant

[symbol]

Also, the input data determination unit 184 interprets the first ordinal information N(1) and recognizes that a single input signal is generated from the input signal generators 171′ to 176′ before an input signal generates from the input signal generator 177′. Then, based on the pair character list, the input data determination unit 184 determines finally that a counterpart [symbol] of the character [symbol] is character to be inputted.

Second signal S174 of the input signal group SG2 has been generated by the input signal generator corresponding to button 174 on the button generator connection list. Then, based on the character designation button list, the input data determination unit 184 recognizes that a Korean vowel [symbol] is designated by the character designation button 174 among [symbol] [symbol] [symbol] and [symbol] assigned to character input button 174 and determines that an input character corresponding to SG2 is a Korean vowel

[symbol]

Then the input data determination unit 184 interprets the second ordinal information N(2) and recognizes that two input signals are generated from the input signal generators 173 and 174 between the two input signal generations from the input signal generator 177′. Then, based on the pair character list, the input data determination unit 184 determines finally that a counterpart [symbol] of the character [symbol] is character to be inputted.

Subsequently, based on the character designation button list, the input data determination unit 184 recognizes that an lowercase English letter “i” is designated by the character designation button 176 among “f”, “g”, “h”, “i”, “j” and “k” assigned to character input button 176 and determines that an input character corresponding to SG3 is lowercase English letter “i”.

Then the input data determination unit 184 interprets the second ordinal information N(2) and recognizes that two input signals are generated from the input signal generators 174 and 176 between the two input signal generations from the input signal generator 177′. Then, based on the pair character list, the input data determination unit 184 determines finally that a counterpart “I” of the lowercase English letter “i” is character to be inputted.

To input a pair character in the data input device as shown in FIGS. 37 and 38, the user has to press the pair character selection button after pressing a character input button and before pressing a character designation button. Alternatively, the pair character selection button can be set to be pressed after pressing a character input button and a character designation button.

According to the preferred embodiments of the present invention as explained above, one of the characters assigned to character input button can be designated by pressing one time a character designation button, which eliminates the need to distribute characters on an increased number of buttons (for the purpose of reducing the number of button pressings). And the number of buttons is determined depending on the number of character designation buttons. Accordingly the number of the total buttons can be reduced. As the result of the reduction of buttons, the space efficiency of a data inputting electric/electronic device can be improved. Moreover, a sufficient size of each button can reduce the possibility that the user presses a wrong button.

Since a desired character can be inputted by pressing in sequence a corresponding character input button and a corresponding character designation button, a larger number of characters in the same class can be assigned to each character input button, as compared to a conventional data input device. Accordingly, users can easily find a desired character to be inputted.

According to the preferred embodiments of the present invention, users can designate one character among characters assigned to a character input button based on the disposition pattern of character designation buttons and the disposition pattern of characters on each character input button, or the colors of character designation buttons and the colors of characters on each character input button, or the disposition order of character designation buttons and the print order of characters on each character input button. Accordingly, errors in the data inputting process can be reduced.

The data input devices according to the preferred embodiments of the present invention can be configured to display on a display unit the input character determined by the input data determination unit (as in the conventional data input devices).

According to the preferred embodiments of the present invention, the pressing of a character input button is followed by the pressing of a character designation button. However, the data input device can be configured to press first a character designation button before a character input button is pressed.

Although methods for inputting Korean characters, English characters according to the preferred embodiments of the present invention have been explained, numbers, markings or icons can also be inputted by the same methods.

In addition, although the data input device explained above is applied to a mobile phone in the preferred embodiments of the present invention, it is equally applicable to computer keyboards, mouse devices, keypads, remote controllers, game controllers, electronic notes, PDAs, encoders and other terminals.

### INDUSTRIAL APPLICABILITY

As can be seen from the foregoing, the number of the total buttons of the present invention is reduced, thereby improving the space efficiency of a data inputting electric/electronic device and increasing the size of each button.

Since a larger number of characters in the same class can be assigned to each character input button, users can easily find a desired character to be inputted.

Also, since users can designate one character by one pressing of character designation button among characters assigned to a character input button, it is possible to reduce an error that frequently occurs when the user fails to accurately count the number of pressings of a single button in the prior art.

While this invention has been described in connection with what is presently considered to be the most practical and preferred embodiment, it is to be understood that the invention is not limited to the disclosed embodiment and the drawings, however, on the contrary, it is intended to cover various modifications and variations within the spirit and scope of the appended claims.

1. A data input device comprising one or more character input buttons and character designation buttons, each having two operating states, input signal generators corresponding respectively to the plurality of buttons and generating input signals when the buttons are pressed, and an input data information generator for generating input data information based on the input signals from the input signal generators,
characterized in that said input data information generator includes a memory for storing a button generator connection list showing connection relationship between each button and each corresponding input signal generator, a character assignment list showing relationship each character input button and characters to be assigned to each character input button and a character designation button list showing relationship each character designation button and characters to be designated as input state by each character designation button, and that said input data information generator groups the input signals generated from the input signal generators two by two according to the generation order and determines one character to be designated by the character designation button corresponding to one of each input signal group among the characters to be assigned to the character input button corresponding to the other of each input signal group as an input character based on the three lists stored in the memory.

2. The data input device as claimed in claim 1, wherein said character input buttons are grouped into at least one character input button group according to character disposition pattern thereof,
each character input button belonging to each character input button group includes character print regions that are divided in a number not smaller than the maximum number of characters assigned to each character input button and that the characters assigned to it are printed on the character print regions one by one, and
said character designation button list is generated so that relationship between each character input button group and buttons belonging to each character input button group is included and so that button disposition pattern of each character input button group agrees with character disposition pattern corresponding to each character input button group.

3. The data input device as claimed in claim 2, wherein on at least one of character input buttons belonging to each character input button group, characters are printed into a plurality of character sub-groups, each having the same character disposition pattern,
said memory stores a sub-group selection button list showing relationship sub-group selection buttons and the character sub-groups selected by each sub-group selection button,
said input assignment list is generated so that relationship between each character sub-group and characters belonging to each sub-character group is included, and
said input data information generator determines the character to be selected by each sub-group selection button as an input character based on the sub-group selection button list stored in the memory.

4. The data input device as claimed in claim 2, wherein on at least one of character input buttons belonging to each character input button group, characters are printed into a plurality of character sub-groups, each having the same character disposition pattern,
sub-group selection markings for selecting the character sub-groups are printed on at least one of character input buttons,
said memory stores a sub-group selection marking list showing relationship the sub-group selection markings and the character sub-groups selected by each sub-group selection marking, said character assignment list is generated so that relationship between each character sub-group and characters belonging to each character sub-group is included, and
said input data information generator determines the character to be selected by each sub-group selection marking as an input character based on the sub-group selection marking list stored in the memory.

5. The data input device as claimed in claim 2, wherein each character designation buttons belonging to each character input button group is formed in the same shape as the character disposition pattern on the button.

6. The data input device as claimed in claim 2, wherein said memory stores pair character list showing relationship each character printed on the character input button and its counterpart character,
a pair character selection button is separately provided for selecting counterpart character, and
when an input signal is generated from the input signal generator corresponding to the pair character selection button, said input data information generator determines the counterpart character of the character designated by the character designation button as an input character based on the pair character list stored in the memory.

7. The data input device as claimed in claim 1, wherein said character input buttons are grouped into at least one character input button group according to character colors thereof,
on each character input button belonging to each character input button group, characters assigned to it are printed with a different color belonging to the colors assigned to the each character input group, and on each character designation button corresponding to each character input button group, a character designation marking is printed with a different color belonging to the colors assigned to the each character input group,
said character designation button list is generated so that relationship between each character input button group and buttons belonging to each the character input button group is included, and so that color of each character input button belonging to each character input button group agrees with color of the character designation marking corresponding to each character input button group.

8. The data input device as claimed in claim 7, wherein on at least one of character input buttons belonging to each character input button group, characters are printed into a plurality of character sub-groups, each having the same group colors,
said memory stores a sub-group selection button list showing relationship sub-group selection buttons and the character sub-groups selected by each sub-group selection button,
said input assignment list is generated so that relationship between each character sub-group and characters belonging to each sub-character group is included, and
said input data information generator determines the character to be selected by each sub-group selection button as an input character based on the sub-group selection button list stored in the memory.

9. The data input device as claimed in claim 7, wherein on at least one of character input buttons belonging to each character input button group, characters are printed into a plurality of character sub-groups, each having the same group colors,
sub-group selection markings for selecting the character sub-groups are printed on at least one of character input buttons,
said memory stores a sub-group selection marking list showing relationship the sub-group selection markings and the character sub-groups selected by each sub-group selection markings,
said character assignment list is generated so that relationship between each character sub-group and characters belonging to each character sub-group is included, and
said input data information generator determines the character to be selected by each sub-group selection marking as an input character based on the sub-group selection marking list stored in the memory.

10. The data input device as claimed in 1, wherein said character input buttons are arrayed in a specific order and on the character input button the characters assigned to it printed in the same order, and
said character designation button list is generated so that button array order agrees with character print order.

11. The data input device as claimed in claim 1, wherein at least some of said character input buttons are formed in a multi-contact type button body.

12. The data input device as claimed in claim 11, wherein four character input buttons, each having four character print regions disposed in a rectangular pattern, are formed at four corners of a rectangular multi-contact type button body having a parallelogram opening at the center thereof, and other four character input buttons, each having character print regions disposed in a parallelogram pattern, are formed at four corners of a parallelogram multi-contact type button body installed through the parallelogram opening.

13. The data input device as claimed in claim 11, wherein four character input buttons, each having four character print regions disposed in a rectangular pattern, are formed at four arms of a cross-shaped multi-contact type button body, and other four character input buttons, each having four character print regions disposed in a rectangular pattern, are formed separately between every two arms of the cross-shaped multi-contact type button body.

14. The data input device as claimed in claim 11, four character input buttons, each having four character print regions disposed in a rhombic pattern, are formed at four corners of a rhombic outer multi-contact type button body having a rhombic outer opening at the center thereof, and other four character input buttons, each having four character print regions disposed in a rhombic pattern, are formed at four corners of a rhombic inner multi-contact type button body installed through the rhombic outer opening, other four character input buttons, each having four character print regions disposed in a rhombic pattern, are formed are formed separately installed in a rhombic pattern through the rhombic inner opening.

15. The data input device as claimed in claim 1, wherein each character designation button is provided with a protruded dot or dots for discriminating each other.

16. A method for inputting character data using a data input device with one or more character input buttons and character designation buttons, each having two operating states, through steps of pressing the buttons, generating input signals corresponding to the pressed buttons and generating input data information based on the input signals,
characterized in that said input data information generation step includes: generating a button generator connection list showing connection relationship between each button and each corresponding input signal generator; generating a character assignment list showing relationship each character input button and characters to be assigned to each character input button; generating a character designation button list showing relationship each character designation button and characters to be designated as input state by each character designation button; grouping groups the input signals generated from the input signal generators two by two according to the generation order; and determining one character to be designated by the character designation button corresponding to one of each input signal group among the characters to be assigned to the character input button corresponding to the other of each input signal group as an input character based on the three lists.

17. The method as claimed in claim 16, wherein said character input buttons are grouped into at least one character input button group according to character disposition pattern thereof,
each character input button of each character input button group includes character print regions that are divided in a number not smaller than the maximum number of characters assigned to each character input button and that the characters assigned to it are printed on one by one, and
said character designation button list generation step generates so that relationship between each character input button group and buttons belonging to each the character input button group is included and so that button disposition pattern of each character input button group agrees with character disposition pattern corresponding to each character input button group.

18. The method as claimed in claim 17, wherein on at least one of character input buttons belonging to each character input button group, characters are printed into a plurality of character sub-groups, each having the same character disposition pattern,
said input data generation step further includes generation of a sub-group selection button list showing relationship sub-group selection buttons and the character sub-groups selected by each sub-group selection button,
said input assignment list generation step generates so that relationship between each character sub-group and characters belonging to each sub-character group is included, and
said input data determination step determines the character to be selected by each sub-group selection button as an input character based on the sub-group selection button list.

19. The method as claimed in claim 17, wherein on at least one of character input buttons belonging to each character input button group, characters are printed into a plurality of character sub-groups, each having the same character disposition pattern,
sub-group selection markings for selecting the character sub-groups are printed on at least one of character input buttons,
said input data generation step further includes generation of a sub-group selection marking list showing relationship the sub-group selection markings and the character sub-groups selected by each sub-group selection markings,
said input assignment list generation step generates to include relationship between each character sub-group and characters belonging to each sub-character group, and
said input data determination step determines the character to be selected by each sub-group selection button as an input character based on the sub-group selection button list.

20. The method as claimed in claim 19, wherein said character input buttons are grouped into at least one character input button group according to character colors thereof,
on each character input button belonging to each character input button group, characters assigned to it are printed with a different color belonging to the colors assigned to the each character input group and on each character designation button corresponding to each character input button group, a character designation marking is printed with a different color belonging to the colors assigned to the each character input group,
said character designation button list generation step generates to include relationship between each character input button group and buttons belonging to each the character input button group and so that color of each character input button belonging to each character input button group agrees with color of the designation marking corresponding to each character input button group.

21. The method as claimed in claim 20, wherein on at least one of character input buttons belonging to each character input button group, characters are printed into a plurality of character sub-groups, each having the same group colors,
said input data generation step further includes generation of a sub-group selection button list showing relationship sub-group selection buttons and the character sub-groups selected by each sub-group selection button,
said input assignment list generation step generates so that relationship between each character sub-group and characters belonging to each sub-character group is included, and
said input data determination step determines the character to be selected by each sub-group selection button as an input character based on the sub-group selection button list.

22. The method as claimed in claim 20, wherein on at least one of character input buttons belonging to each character input button group, characters are printed into a plurality of character sub-groups, each having the same group colors,
sub-group selection markings for selecting the character sub-groups are printed on at least one of character input buttons,
said input data generation step further includes generation of a sub-group selection marking list showing relationship the sub-group selection markings and the character sub-groups selected by each sub-group selection markings,
said input assignment list generation step generates so that relationship between each character sub-group and characters belonging to each sub-character group is included, and
said input data determination step determines the character to be selected by each sub-group selection button as an input character based on the sub-group selection button list.

23. The method as claimed in claim 16, wherein said character input buttons are arrayed in a specific order and on the character input button the characters assigned to it printed in the same order,
said character designation button list generation step generates so that button array order agrees with character print order.
